(19) United States
(12) Patent Application Publication
(10) Pub. No.: US 2026/0025350 A1
(43) Pub. Date: Jan. 22, 2026

(54) METHODS AND SYSTEMS FOR INTERNET PROTOCOL (IP) WARMING

(71) Applicant: Adobe Inc., San Jose, CA (US)

(72) Inventors: Shivam Goel, San Jose, CA (US); Medha Kumari, San Jose, CA (US); Shiladitya Bose, Noida (IN); Siddharth Jain, New Delhi (IN)

(73) Assignee: Adobe Inc., San Jose, CA (US)

(21) Appl. No.: 18/777,071

(22) Filed: Jul. 18, 2024

(51) Int. Cl. H04L 51/214; G06Q 30/0204

(52) U.S. Cl. CPC H04L 51/214; G06Q 30/0204

(57) ABSTRACT

Embodiments are generally directed to systems and methods for Internet protocol (IP) warming. One method of generating content includes determining, via an audience orchestration module, an Internet protocol (IP) warming audience configured for an IP warming process; determining, via an IP warming module, an IP warming schema formed of a plan configured using a plan module, the IP warming plan comprising phases formed of a plurality of runs, wherein each run identifies a number of communications to transmit to at least one domain to the IP warming audience; and executing an IP warming process configured based on the IP warming schema for IP warming an IP address used to send communications. Other embodiments are described.

### BACKGROUND

Email campaigns are a common method for enterprises to efficiently reach a large audience. However, the case of legitimate email usage also allows for problematic users to proliferate emails that range from merely being unwanted by recipients to actually being malicious, such as “spam” or “junk” emails, computer viruses, and phishing or other attacks. Accordingly, service providers that facilitate email communications, such as Internet service providers (ISPs), email service providers (ESPs), or other email inbox, providers support various functions to mitigate unwanted and malicious email activity.

Examples of mitigating functions include spam filters and blacklists (e.g., blocking email from certain domains, Internet protocol (IP) addresses, and/or the like). In addition, service providers typically regulate sender email volume based on the reputation of the sender. Internet Protocol (IP) warming or warm-up is the practice of establishing a reputation with email service providers. When a sender uses a new domain or IP address to begin distributing content, such as emails, through an ESP, the ESP will typically require IP warming for the new IP address before the content distributor can send large volumes of emails using the new IP address.

Warming up an IP address using current techniques typically involves sending low volumes of email on a dedicated IP address and then systematically increasing the email volume over a period of time. This process provides service providers with the opportunity to recognize, identify, and evaluate the sending practices of content distributors before allowing large volumes of content to be distributed through the service providers. If a content distributor does not properly warm up a new IP address, service providers may choose to not deliver emails from the new IP address or to label emails from the new IP address as “spam” or “junk” (which may not be delivered to recipients' main inboxes).

Using current technologies, IP warming has been a labor-intensive process, involving the manual creation of creatives, segmentation, audiences, schedule management, and daily execution and monitoring by content distributors. As a result, existing methods are prone to human error, lack scalability, are inefficient, and often lead to inconsistencies in IP warming performance.

### SUMMARY

Embodiments are generally directed to systems and methods for Internet Protocol (IP) warming. More specifically, embodiments are directed to a schema-based approach to IP warming that provides content distributors with dynamic data models and processes configured to facilitate automated and efficient IP warming for content distributors.

Some embodiments provide an IP warming system configured to achieve IP warming of a sender domain or sender IP address (i.e., a domain or IP address used to send content) for distributing content through a service provider, such as an internet service provider (ISP) or an email service provider (ESP). The IP warming system uses a schema that includes three hierarchical levels: a plan level, a phase level, and a run level. The plan level is configured as the foundational level of the IP warming schema, representing an overarching strategy for IP warming. In some embodiments, plans implement multiple phases and configurations, serving as the blueprint for an IP warming process. Phases are configured as intermediate levels within the IP warming schema, representing specific stages or milestones within an IP warming process or journey. Phases allow for operations such as splitting, adding, or deleting, enabling dynamic management and optimization. The run level is an operational phase of the IP warming schema, encompassing individual executions of the IP warming process. Runs are associated with specific recipient domains (i.e., a domain of a recipient used for receiving content, such as gmail.com or outlook.com for receiving emails) and schedules, facilitating targeted engagement and evaluation of performance metrics.

Any of the above embodiments may be implemented as instructions stored on a non-transitory computer-readable storage medium and/or embodied as an apparatus with a memory and a processor performs the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system in accordance with embodiments described in the present disclosure.

FIGS. 2A-2D illustrate example IP warming graphical user interface (GUI) screens according to embodiments described in the present disclosure.

FIG. 3 illustrates an example system in accordance with embodiments described in the present disclosure.

FIG. 4 illustrates an example of an Internet protocol (IP) warming schema in accordance with embodiments described in the present disclosure.

FIG. 5 illustrates an example of configuration profiles for an IP warming schema in accordance with embodiments described in the present disclosure.

FIG. 6 illustrates an example of an IP warming plan in accordance with embodiments described in the present disclosure.

FIG. 7 illustrates an example of an IP warming graph in accordance with embodiments described in the present disclosure.

FIG. 8 illustrates an example of rules configured using a rule module in accordance with embodiments described in the present disclosure.

FIG. 9 illustrates an example of a processing flow for IP warming audience creation in accordance with embodiments described in the present disclosure.

FIG. 10 illustrates an example of an IP warming architecture in accordance with embodiments described in the present disclosure.

FIG. 11 illustrates an example of a process flow for an IP warming process in accordance with embodiments described in the present disclosure.

FIG. 12 illustrates an example of a process flow of an IP warming process within a message runtime resource manager architecture in accordance with embodiments described in the present disclosure.

FIG. 13 illustrates an example of an IP warming architecture in accordance with embodiments described in the present disclosure.

FIG. 14 illustrates a routine in accordance with embodiments described in the present disclosure.

FIG. 15 illustrates a routine in accordance with embodiments described in the present disclosure.

FIG. 16 illustrates a routine in accordance with embodiments described in the present disclosure.

FIG. 17 illustrates a computer-readable storage medium in accordance with one embodiment.

### DETAILED DESCRIPTION

Network service providers often monitor the reputation of network users attempting to send content, communications, and/or the like over a network. The reputation of a network user may affect the ability of communications from the network user to reach intended recipients. For example, service providers, such as Internet service providers (ISPs), email service providers (ESPs), mailbox providers (MBPs), and/or the like, often maintain a reputation indicator or reputation score for each sender or sender system (e.g., IP address). In other examples, sender reputation indicators or scores are maintained by an ISP, for instance, as ESPs, MBPs, and/or the like are involved in sending communications (for example, bulk emails for email marketing) and not maintaining reputation indicators or scores. The amount of communication messages a network user can send via a service provider and/or the ability of the messages to avoid being flagged as “spam” or “junk” (and, therefore, reaching a recipient's main email inbox) depends on the reputation indicator. Service providers typically maintain the reputation indicator over a specified window or duration. In one example, a sender reputation score is based on reputation activity over the previous 30 days.

Each service provider has their own configuration of factors that are used to determine a sender reputation. Typical key factors include bounces (e.g., message undeliverable), complaints, email volume, email consistency (e.g., whether there are spikes in email volume), spam traps, engagement, click-rate, opt-outs, suppressions, spam indicators, and/or the like. Non-limiting examples of typical communication recipient actions that positively contribute to sender reputation are clicking through links, adding an address to contacts, enabling images, opening and/or scrolling through the communication, and/or the like. Non-limiting examples of typical communication recipient actions that negatively affect sender reputation are reporting communications as spam/junk, deleting a communication, moving the communication to trash, marking communications as read, ignoring messages, unsubscribing from sender communications, and/or the like.

Communication senders are typically identified by service providers based on the Internet Protocol (IP) addresses they are using to interact with the service provider. In general, an IP address is a unique string of numbers used to identify devices (e.g., an email server) on a network, such as the internet. New IP addresses typically start with a low or no reputation score. Accordingly, an IP warming process is required to allow a service provider to send communication, such as emails, from the new IP address above a threshold volume. Alternatively, a reputation score may be required to be over a threshold value in order to change an existing sender's email activity or volume.

Conventional IP warming processes involve creating a reputation of an IP address as a trusted sender of emails so that the service provider will deliver the emails to the intended recipients and at a desired volume. During the warmup period, service providers evaluate sending behavior, email list health, and how committed senders are to providing relevant and valuable information to recipients. The more engagement a sender receives during the warmup period, the better the service providers will favor the subject IP address. Service providers examine factors such as how many users opened an email, scrolled to the bottom of the email, deleted the email, moved the email to other folders (e.g., spam, junk, or archive), unsubscribed, and/or the like.

Conventional IP warming involves gradually increasing the volume of sent emails from the IP address. For example, a typical warming schedule recommends sending 500 emails on the first day, 25,000 emails on the seventh day, 275,000 emails on the fourteenth day, and so on, until 45 million emails can be sent on the thirtieth day. However, this ramping schedule also requires that there are no issues with the sent emails, such as bounce-backs, complaints, spam/junk designations, and/or the like. Typically, it is difficult to repair a negatively impacted reputation (for instance, due to a high percentage of opt-outs on the third day of an IP warming period). Therefore, a major goal of senders is to proceed through IP warming without harming their reputation.

Accordingly, in the ever-evolving landscape of digital marketing, IP warming stands as a crucial strategy to establish trust and credibility with service providers when sending out large volumes of emails. Traditionally, IP warming has been approached in a mechanical manner, relying heavily on manual execution and management by marketers or other practitioners. Using conventional computer and software platforms, a lot of work must be done to set up IP warming using product-specific capabilities around segmentation, conditions, and delivery objects like campaigns, journeys, projects, and/or the like. As a result, a complicated and delicate process must be performed in diverse ways by different people after spending a lot of time initializing, configuring, testing, executing, and then evaluating the results. As a result, IP warming using conventional software tools is a long, complicated activity ranging anywhere from a couple of weeks to multiple months. Therefore, the amount of effort and resources spent to perform the activities required for a standard IP warming process over an extended period is substantially high for practitioners.

For example, using existing software applications, a user is required to formulate and follow a complex pathway with profile capping, segmentation, and pathway conditions to start with a base audience, filter out unwanted profiles, split on basis of recipient domains, evaluate recipient engagement, and cap to desired volume for each recipient domain to send out a communication.

Standard software tools for IP warming are also ineffective at testing the IP warming process. For example, the results for an IP warming process can change daily, requiring monitoring and user responses in order to proceed through the IP warming process successfully. For instance, on a first day of IP warming, a negative recipient action (i.e., unsubscribe requests) may be below a problematic threshold, but may rise above the problematic threshold on the second day. Standard software tools require user monitoring and direct intervention in order to address such changes. For example, a user may be required to drill down into specific IP warming pathways, and particular segments of a pathway, to address IP warming issues (e.g., manually changing the email domain used on a batch of IP warming emails). For instance, conventional software tools may include pathways for each email domain used in a warming process (e.g., gmail.com, hotmail.com, etc.) with segments associated with certain conditions (e.g., engagement data, profile caps or limits, etc.) that can affect IP warming results. A user is required to individually evaluate each segment of all domain pathways before and after each batch of emails are transmitted each day. In another instance, each email domain can be associated with different results. For example, a batch of 1000 IP warming emails to the gmail.com domain and the outlook.com domain may have received 200 undeliverable responses, with 90% of the undeliverable responses coming from the outlook.com domain. Using standard software tools, a user is required to drill down directly into the results for each condition for each email domain in order to determine the results of previous IP warming email batches. This process consumes excessive resources and is prone to error.

Existing software tools provide basic IP warming capabilities such as rate limiting, profile capping, segmentation, and conditioning. Service providers, such as ESPs, typically provide IP warming capability via documented plans (i.e., ramping schedules) and an inefficient workflow that is generic for regular executions. As a result, communication senders end up with one or more sub-optimal paths for IP warming, leading to unnecessary and costly delays for launching new systems (e.g., new communication servers, ISPs, and/or the like) and communication campaigns.

Conventional IP warming systems, including computer-based systems, are not able to adequately assist the user in the IP warming process. For example, existing IP warming systems do not provide the processes necessary for optimized, efficient IP warming. In another example, existing IP warming systems do not provide granular control over operational aspects of an IP warming process with a service provider. In an additional example, existing IP warming systems do not provide the use of configuration schema for executing IP warming processes. In a further example, existing IP warming systems do not provide the ability to create and use an efficient and dynamic workflow for managing and testing live IP warming projects that do not require deep knowledge or large teams of users.

Accordingly, embodiments provide a schema-based approach to IP warming. In general, a schema-based approach uses specifically programmed computing modules to execute an IP warming process. The programed computing modules are configured to perform an IP warming process that includes executing an email campaign to send batches of emails to a particular set of recipient email addresses on a specified schedule to achieve IP warming success. In one example, IP warming success includes achieving a target reputation score with one or more service providers (e.g., a score of over 80 on a 0-100 scale). In another example, IP warming success includes achieving the ability to send a target number of emails via one or more service providers (e.g., over 100,000 emails per day). In a further example, IP warming success includes achieving the ability to send emails to a target number of users (e.g., profiles or email addresses). In general, an email campaign is a coordinated set of individual email messages that are deployed to a defined audience across a specific period of time with a specific purpose. The IP warming process according to some embodiments implements an IP warming campaign to achieve IP warming success.

In some embodiments, the schema-based approach uses a plan level, a phase level, and a run level. The plan level is a high-level, comprehensive structure for an IP warming process. The plan level is configured as a foundational level that defines an overarching strategy for IP warming. For example, the plan level can define strategies for IP warming content, target audiences, target domains, email volume ramping, and/or responses to email transmission results. The plan level IP warming strategy is defined through the configuration of phase levels, run levels, and rules.

The phase levels and run levels are defined within a plan. For example, a user creates a new or “blank” plan (e.g., “Plan A”). Plan A is created spanning over 17 days (each day is a “run”) to eventually reach a target volume of over one million emails. Six phases are defined within Plan A, with each phase assigned or otherwise associated with a different email campaign. A different campaign is selected for each phase. The 17 days (or runs) are defined within the six phases (e.g., phase 1 includes runs 1-5 for Campaign A, phase 2 includes runs 6-8 for Campaign B, and so on). Each run specifies a number of emails to be transmitted that day. For instance, run 1 specifies sending 5,000 emails of Campaign A. The run may split the emails among different domains. For instance, 2,000 of the 5,000 emails or run 1 may be sent to the Gmail® domain; 2,000 emails may be sent to the Yahoo® domain; and 1,000 emails may be sent to a Microsoft® domain.

In some embodiments, plans house multiple phases and configurations, serving as the blueprint for an IP warming process. Phases are configured as intermediate levels within an IP warming plan. In some embodiments, phases are configured to represent specific stages or milestones within an IP warming process or journey. For example, completion of a phase represents the transmission of all of the emails of a specific campaign. In another example, completion of a phase represents the transmission of emails to a specific audience segment. As described in more detail below, phases allow for operations such as splitting, adding, or deleting, enabling dynamic management and optimization.

The run level is an operational level of an IP warming plan encompassing individual executions of the IP warming process. For example, a run includes the actual transmission of a specified batch of emails. Runs are associated with specific domains and schedules, facilitating targeted engagement and evaluation of performance metrics. Run-level operations offer granular control over domain-group counts and engagement criteria, enhancing targeting precision.

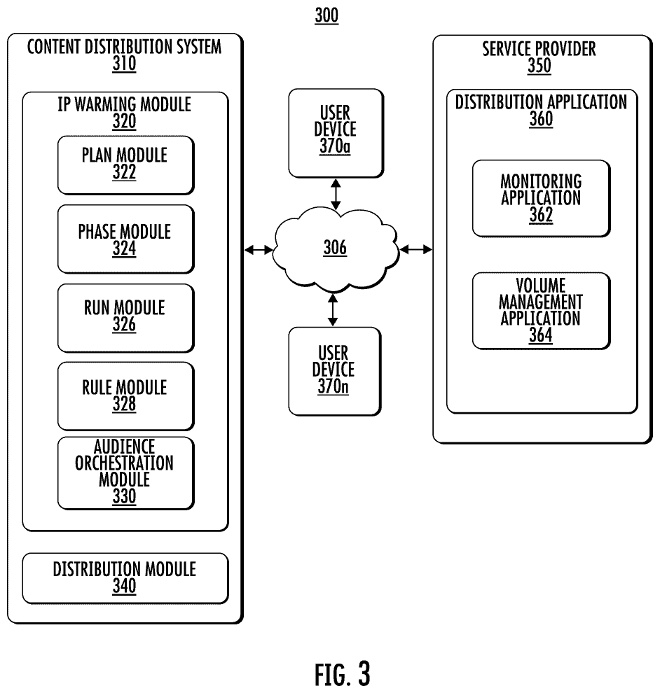

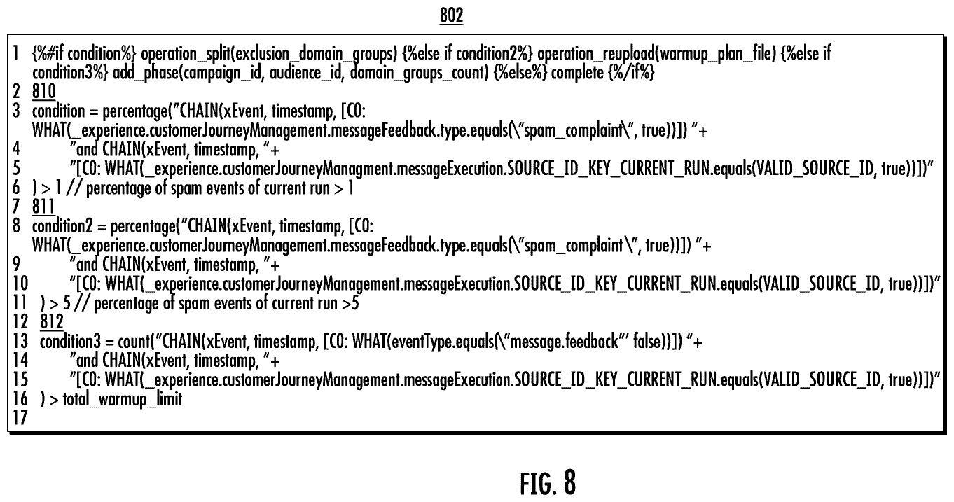

Some embodiments include a rule-based decisioning module (or “rule module;” see, for example, FIGS. 3 and 8). In various embodiments, the rule module provides predefined actions based on specified conditions. In some embodiments, a rule has the form: if <distribution metric> is >/</=to a threshold, perform <change/action>. One non-limiting example of a rule involves a user-defined rule stating that if the bounce rate for a specific domain group exceeds x %, the system automatically initiates a split phase operation and adds that domain group to a domain exclusion list for the new phase.

The proactive approach facilitated by the IP warming system according to some embodiments facilitates timely intervention in response to emerging issues, thereby minimizing the need for human involvement and mitigating, or even completely eliminating, potential costly delays.

In a conventional process, a user desires to initiate using an IP address to send large-volume email campaigns (for instance, campaigns with greater than 100,000 emails). If the user begins sending large volumes of email for the campaign without IP warming, the IP address will be associated with a low reputation score and the emails will be blocked, labeled as spam/junk, etc. The user can proceed with IP warming, but they have minimal understanding of aspects of the IP warming process. For example, the user does not know the configuration of campaigns and audience segments optimized and most efficient for IP warming (as opposed to, for instance, marketing campaigns and audience segments). The user also does not have meaningful insight into the various IP warming requirements, factors, metrics, and/or the like for each service provider. The user also has limited resources to monitor the large number of emails and the actions of the recipients, especially for each email domain that the user seeks to use as part of their email campaigns.

Advantageously, embodiments disclosed herein provide an IP warming process to facilitate IP warming that is easier, more efficient, and less error-prone than provided by existing systems, including existing computer- and software-based techniques. In one non-limiting example of a technological advantage, some embodiments implement run-level operations that facilitate granular control over domain-group counts and engagement criteria, enhancing audience and domain targeting precision. The audience and domain targeting precision allows for the creation and use of specific IP warming campaigns and audiences (as opposed to relying on traditional or existing marketing campaigns and audiences). This technological advantage provides increased efficiency compared with existing systems because the granular control facilitates achieving faster IP warming success targets.

In one non-limiting example of a technological advantage, some embodiments allow for the creation of an IP warming campaign that dynamically and automatically responds to campaign results. For instance, the number of emails of the next run is modified based on the number of undeliverable emails in a previous run. In another instance, the domain split of emails (e.g., the division of the batch of emails among the email domains) is modified based on the results of a particular email domain. Non-limiting examples of results (or metrics) include changes in communication reception, recipient activity (e.g., deleting emails, unsubscribing, marking emails as spam, and/or the like), and/or the like that could negatively affect the IP warming process. For example, embodiments provide user interfaces for specifying IP warming rules that provide responses to certain IP warming results (for instance, changing the volume to a certain domain based on undeliverable emails to that domain). In this manner, the user can use a system that automatically and proactively responds to potential IP warming issues (and can specify rules and conditions to manage any negative scenario without direct user intervention). This technological advantage provides increased efficiency compared with existing systems because the user is able to use pre-set rules for managing email transmission metrics. In addition, this technological advantage provides for lower errors or other setbacks in the IP warming process because the user is not required to manually review all of different email transmission metrics for each domain and directly configure individual changes to the IP warming pathways.

In one non-limiting example of a technological advantage, some embodiments provide IP warming campaigns that increase IP address reputations (i.e., reputation scores) faster and easier than existing systems. An increase in IP address reputation leads to the ability to send larger numbers of emails in a campaign. Repairing a negative reputation score is challenging and time-consuming, essentially requiring the user to start again at a lower email volume. A negative reputation score may occur due to the transmission of a batch of unsuccessful IP warming emails (e.g., high bounce rate). Advantageously, embodiments are able to determine and evaluate metrics in real-time or near real-time and facilitate changes to various aspects of an IP warming campaign in order to reduce or even eliminate undesired email reception effects on the IP warming process. For example, rule-based decision making within the IP warming process enables execution of predefined actions based on specified conditions for a run triggered based on email transmission metrics. In some embodiments, a rule has the form: if <email transmission metric> is >/</=to a threshold, perform <change/action>. One non-limiting example of a rule defines that if the bounce rate for a specific domain group exceeds x %, the system automatically initiates a split phase operation and adds that domain group to a domain exclusion list for the new phase.

It is impractical, if not impossible, for users to have sufficient knowledge of each aspect of an email campaign (e.g., audience segments, campaign parameters, recipient domains, etc.) or service provider requirement for achieving a reputation score to successfully move through IP warming. By allowing users to create and execute comprehensive IP warming plans without deep knowledge of each aspect of the IP warming process and service provider metrics, embodiments disclosed herein allow any user to generate and execute a successful IP warming campaign without understanding the configuration of all aspects of an IP warming campaign and without requiring the user to expend resources watching over all aspect of the campaign to respond to each campaign result.

Overall, IP warming processes according to some embodiments would allow the user and other content distributers to achieve desired service provider reputation scores faster and easier than is capable using existing computing technologies. As a result, content distributers are able to warm-up new IP addresses (or make changes to content distribution characteristics of existing IP addresses) more efficiently and effectively using IP warming processes according to some embodiments compared with conventional techniques.

In some embodiments, various types of domain groups are provided and/or configured. In general, a domain group is a group of domains belonging to the same service provider, such as an ISP. The domains in a domain group can be grouped based on certain properties including, without limitation, a shared mail exchange (MX) host belonging to an ISP or ESP. A non-limiting example of a domain group is a global domain group. A global domain group provides available major ISP domains (e.g., Gmail—gmail.com, google.com, googlemail.com; Microsoft—hotmail.com, msn.com, outlook.com, hotmail.co.uk; Yahoo—yahoo.com and/or the like). In various embodiments, domain groups include custom domain groups. Custom domain groups include user-defined domain groups. In one example, a custom domain group is defined based on one or more factors. Non-limiting examples of factors include regional ISPs, combinations of domains based on a DNS mail exchange (MX), based on other criteria besides MX, exclusion factors (e.g., Gmail_X—google.com, gmail.com which excludes googlemail.com), and/or the like. In another example, a custom domain group is a user-defined group or list of domains. For instance, a user can define a custom list of only the gmail.com and outlook.com domains.

Some embodiments include an audience generation process tailored specifically for IP warming dynamics. Audience generation creates a set of users or email addresses associated with a set of users. The audience will be sent emails as part of a run. In some embodiments, audience generation is triggered for each run to build the targeted audience for each run. In this manner, the targeted email addresses can be up-to-date and optimized for IP warming. For example, by generating an audience for each run, email addresses targeted in a previous run can be avoided. In another example, by generating an audience for each run, problematic email addresses, domains, and/or the like based on results from previous runs can be avoided.

In one example, audience targeting in each run is dynamically optimized based on parameters such as engagement, consent, and exclusion criteria. This bias toward IP warming intricacies facilitates optimal deliverability and engagement outcomes for the IP warming process. Accordingly, some embodiments provide audience creation and segmentation specifically tailored for IP warming, for instance, as opposed to audience segmentation for marketing outreach. For example, a marketing campaign audience may be selected based on potential marketing results. For example, a marketing campaign audience may be configured to reach a wide audience of users that have visited a vendor website, but have not made a purchase, regardless of their email response activity (e.g., their read rate). However, IP warming campaign audiences may be selected based directly on email response activity and not for potential marketing results (e.g., targeting user profiles with high read rates, low spam designation rates, etc. from the vendor).

An audience can be generated according to the parameters of the campaign associated with the run. For example, the phase that includes the run may be specified for a campaign targeting users born between 1980 and 2000 that visited a particular website within the past three months. In another example, an audience can be segmented based on domain according to definitions of an associated IP warming plan, for instance, dividing the batch of emails between a Gmail® domain and a Yahoo® domain. In another example, an audience can be segmented based on email response activity, such as read rate, unsubscribe rate, delete rate, and/or the like. In this manner, an IP warming audience for a run may be determined to optimize recipient email actions for IP warming (e.g., high read rates, low spam designation rates, low unsubscribe rates, etc.).

As used herein, “content” or any variations thereof refers to any type of visual, graphical, textual, auditory, combinations thereof, and/or the like information for presentation to a recipient. Non-limiting examples of content include digital media, any website, any email, any graphic, any video, any image, any audio, any text, any computer program, and/or any other form of information and/or any combinations thereof.

As used herein, “communication” or any variations thereof refers to any type of content or electronic communication transmitted over a network. Non-limiting examples, of communications include emails, direct messages, instant messages, social media messages, application messages (e.g., messages sent within an application, such as Microsoft® Teams®), short message service (SMS) or text messages, and content posts (e.g., posting content within an application, service, or content sharing platform, such as You Tube®),

As used herein, “IP warming” or “IP warming” (or an “IP warming process”) is a process of generating a reputation of an IP address as a trusted sender of communications by a service provider. The primary goal of IP warming is to ramp up the sending volume of communications to an anticipated “normal” or target level.

As used herein, an “IP warming schema” is a hierarchical process or approach to IP warming that, in some examples, includes the following levels: a “plan level,” a “phase level,” and a “run level.” The plan level includes plans configured to define multiple phases and configurations for the IP warming schema, serving as the blueprint for an IP warming process. The phase level includes phases configured as intermediate levels within the IP warming schema, representing specific stages or milestones within an IP warming process or journey. The run level is an operational phase of the IP warming schema, encompassing individual executions of the IP warming process. Runs are associated with specific recipient domains (i.e., a domain of a recipient used for receiving content, such as gmail.com or outlook.com for receiving emails) and schedules, facilitating targeted engagement and evaluation of performance metrics.

As used herein, a “service provider” is a system (and associated hardware, software, and/or networking technologies) operative to provide communication over a network. Non-limiting examples of service providers include ISPs, ESPs, MBPs, application platforms, cloud-computing platforms, X-as-a-service (XaaS) platforms, social media platforms, content sharing/publishing platforms, and/or the like. In some examples, a service provider performs IP warming on a content distributor and/or an IP address of a content distributor.

As used herein, a “content distributor” is a system configured to send communications, for instance, computer hardware, software, and/or networking technologies operative to transmit communications via a service provider. Non-limiting examples of content distributors include marketers, advertisers, content creators, content publishers, and/or the like.

As used herein, “large-volume communications” involve the sending of a sufficient number of communications to require IP warming by a service provider. The threshold number of communications required to be large-volume is dependent on the individual settings of each service provider. In general, a large-volume sender sends greater than 1000 emails per month. In some examples, large-volume includes greater than 10,000 emails per month, greater than 50,000 emails per month, greater than 100,000 emails per month, greater than 1 million emails per month, greater than 50 million emails per month, etc.

As used herein, an “audience” or “audience segment” is a segment, division, group, or other collection of individuals intended to receive or access a communication. An audience segment can be defined or divided based on various characteristics, including, without limitation, age, gender, income, education, occupation, experience level, exposure (e.g., to content, a product, and/or the like), associated devices, software downloads, associated content consumption mediums and/or platforms, and/or the like. An “IP warming audience” is an audience specifically defined for an IP warming process based on certain criteria or characteristics supporting successful IP warming. An IP warming audience may be created by extracting recipients from a base audience using specific criteria and segmentation methods tailored for IP warming (e.g., recipient email actions), for instance, as opposed to audience segmentation for marketing outreach (e.g., sales potential, website visit potential, and/or the like). Non-limiting examples of IP warming audience criteria include engagement, consent, exclusion criteria, and email actions (e.g., read rate or prediction, unsubscribe rate or prediction, spam designation or prediction, and/or the like).

As used herein, a “sender domain” or “sender IP address” is a domain or IP address used by a sender, for instance, a sender using the IP warming process, to send content, communications, emails, and/or the like.

As used herein, a “recipient domain” or “recipient IP address” is a domain or IP address used by a recipient or other user to receive content (i.e., from a sender domain or sender IP address through a service provider). Non-limiting examples of recipient domains include gmail.com, outlook.com, yahoo.com, hotmail.com, msn.com.

As used herein, a “domain group” is a group of domains belonging to the same service provider, such as an ISP. The domains in a domain group can be grouped based on certain properties including, without limitation, having the same mail exchange (MX) host belonging to an ISP or ESP.

As used herein, “metrics” or “distribution metrics” are data associated with recipient email actions, including user interactions with transmitted content. Metrics can indicate the success or failure of an IP warming process. Non-limiting examples of metrics include click rates, read rates, delete rates, spam designation (a user designating an email as spam) rates, or suppression (e.g., opting-out, unsubscribing, etc.) rates.

As used herein, “engagement” or “engaged profiles” includes users, email addresses, and/or the like that have interacted with sender content or a sender product, service, platform, media, and/or the like. In one example, an engaged profile is a user that has purchased a product from a sender e-commerce website. In another example, engagement includes a user reading an email sent to the user by the sender.

As used herein, “targeted” or “targeted profiles” include users, email addresses, and/or the like that have previously been targeted by the sender. In some examples, targeted users are removed from an IP warming audience, for IP warming or for a particular phase/run (e.g., to remove users have previously received sender emails, content for a particular campaign, and/or the like).

As used herein, “capping” or “domain-based capping” includes limiting a number of recipients for a domain. In one example, an IP warming audience can be defined by capping or limiting the audience to X email addresses for gmail.com and Y email addresses for outlook.com.

As used herein, “rules” are defined for intervening in or modifying an IP warming process (or portion thereof) based on criteria, metrics, and/or the like. In some examples, a rule has the form: if <condition> is >/</=to a threshold, perform <change/action>. One non-limiting example of a rule involves a user-defined rule stating that if the bounce rate for a specific domain group exceeds x %, the system automatically initiates a split phase operation and adds that domain group to domain exclusion list for the new phase.

As used herein, “splitting” a phase involves taking the remaining runs in a phase and placing them in a new phase for execution during an IP warming process. When a phase is split, a new phase is created and each run of the split phase is transferred to the new phase.

As used herein, “reputation,” “reputation score,” or “reputation indicator” is a reputation of a communication sender (or an IP address used by a communication sender) maintained by a service provider to indicate the quality of the communications transmitted by the communication sender. For example, the reputation score of an IP address may indicate the usefulness of the emails to recipients sent via the IP address. An IP address that sends a large volume of emails that have negative recipient responses (e.g., deleted, unread, unsubscribed, bounces, etc.) would have a lower reputation score than an IP address that sends emails with higher positive recipient responses (e.g., reads, clicks, purchases, etc.). A service provider can use a reputation score as an indicator for how much email the service provider will allow to be transmitted through an IP address (e.g., an IP address with a score of 50 (out of 100) may only be allowed to transmit 1000 emails per day, while an IP address with a score of 90 may be allowed to send 1 million emails per day).

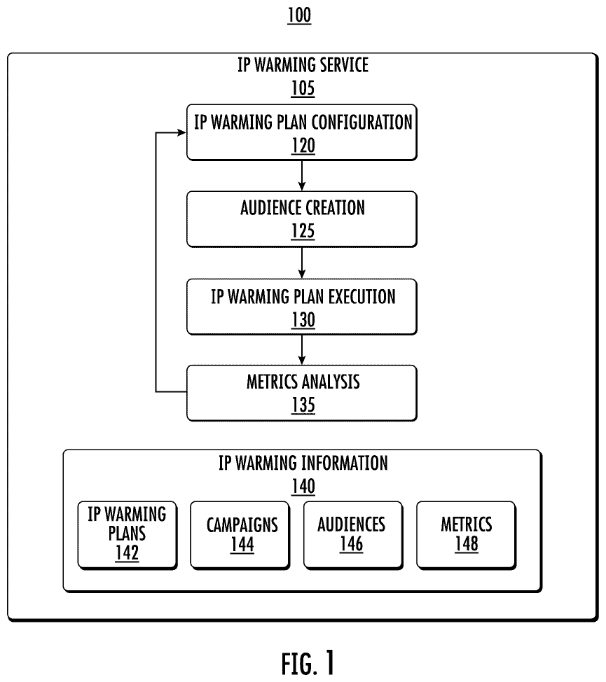

FIG. 1 illustrates an embodiment of a system 100. The system 100 is suitable for implementing one or more embodiments as described herein. In one embodiment, for example, the system 100 is an automated IP warming system. In some embodiments, the system 100 and/or components thereof are implemented via one or more processors of a computing device, such as a server computing device.

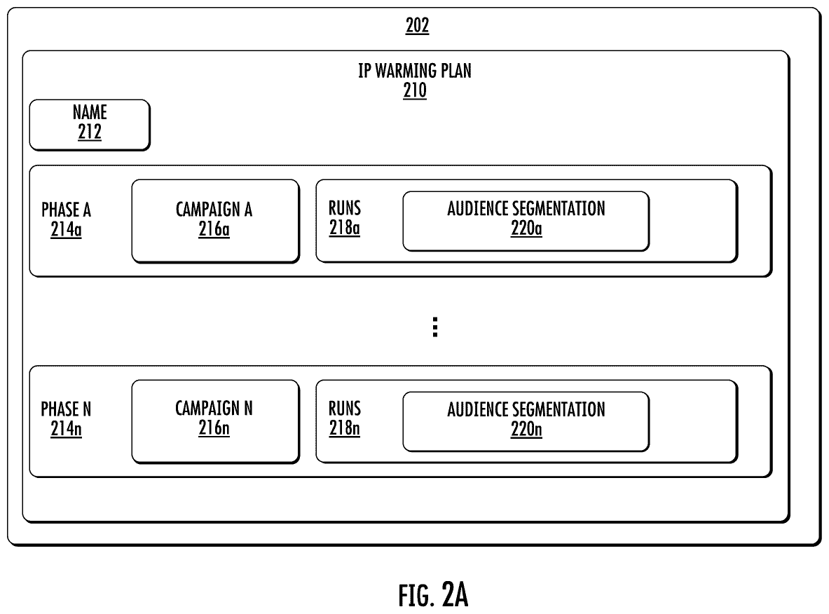

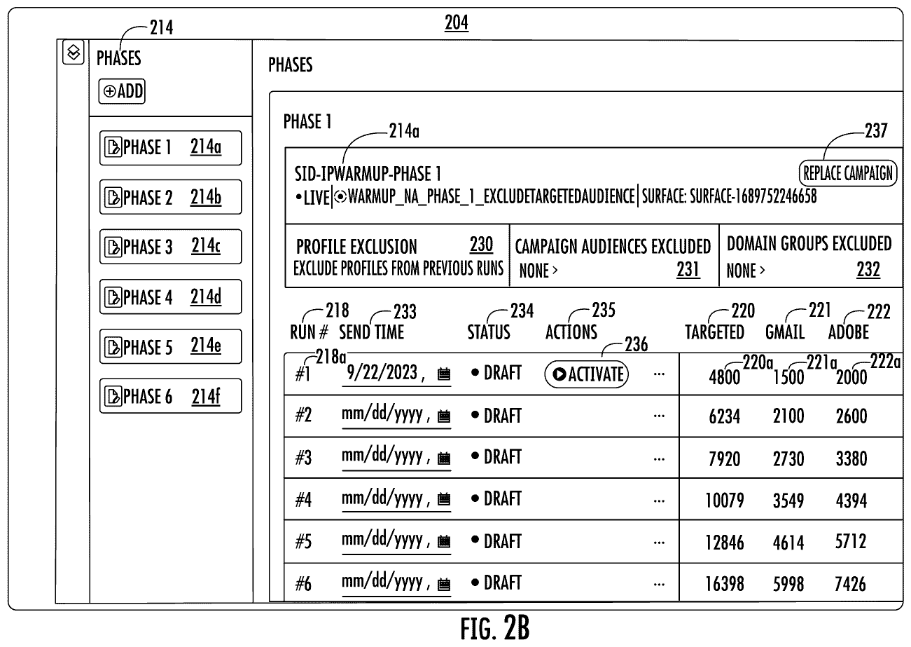

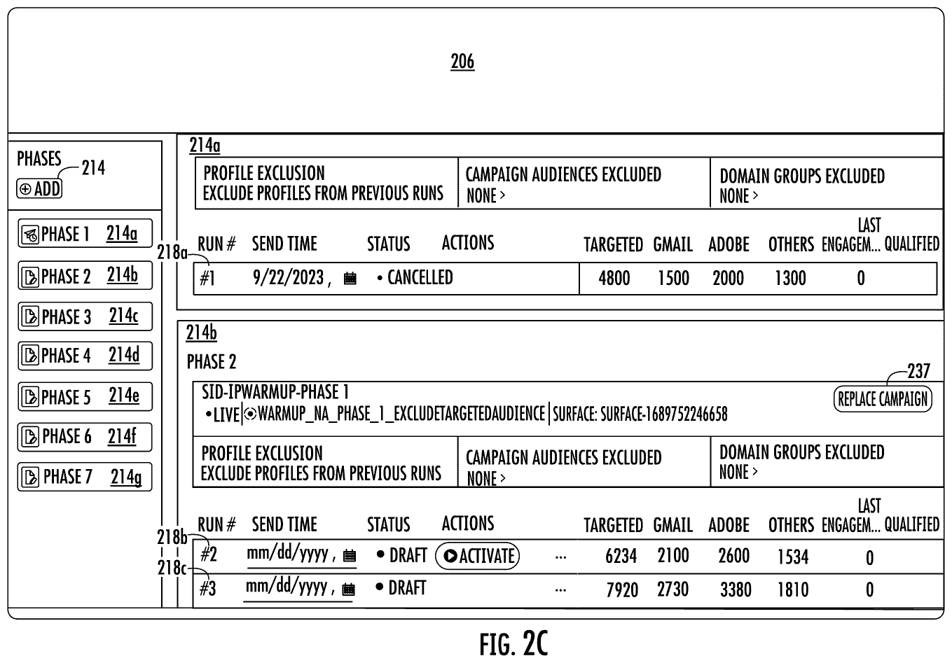

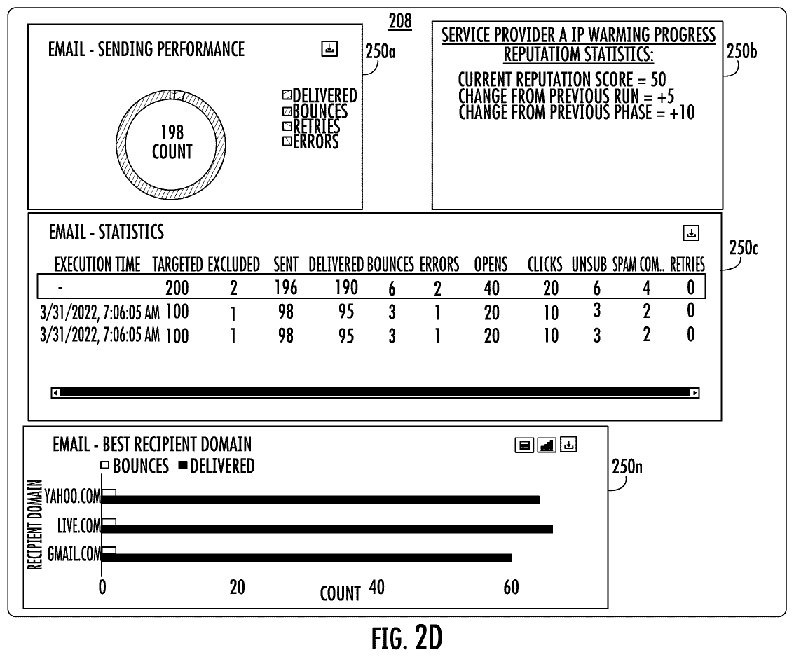

As shown in FIG. 1, the system 100 includes an IP warming service 105 for providing various functions and graphical user interfaces (GUIs) (see, for example, FIGS. 2A-2D) to allow a user to perform IP warming according to some embodiments. The IP warming service 105 uses various IP warming information 140 for configuring and executing IP warming plans according to some embodiments. Non-limiting types of IP warming information 140 include IP warming plans 14, campaigns 144, audiences 146, and metrics 148. The IP warming information 140 may be stored within the system 100 or accessed remotely, for instance, via one or more communication networks operably coupled to the system 100.

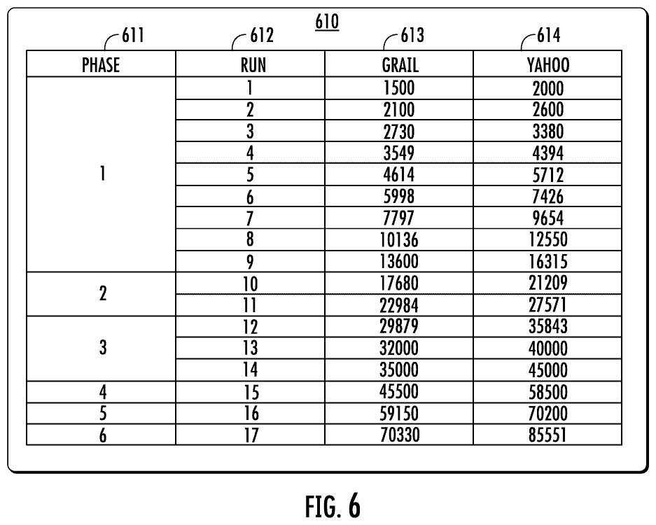

The IP warming service 105 includes IP warming plan configuration 120 for generating new and/or modifying existing IP warming plans. FIG. 2A depicts a GUI or screen 202 for configuring an IP warming plan 210. In some embodiments, the IP warming plan 210 is created within screen 202. In other embodiments, the IP warming plan 210 is created within a separate file (e.g., a comma separated values (.csv) file) and is uploaded into the IP warming service 105 via screen 202 (see, for example, FIG. 6). In some embodiments, the IP warming plan 210 is stored as IP warming plans 142.

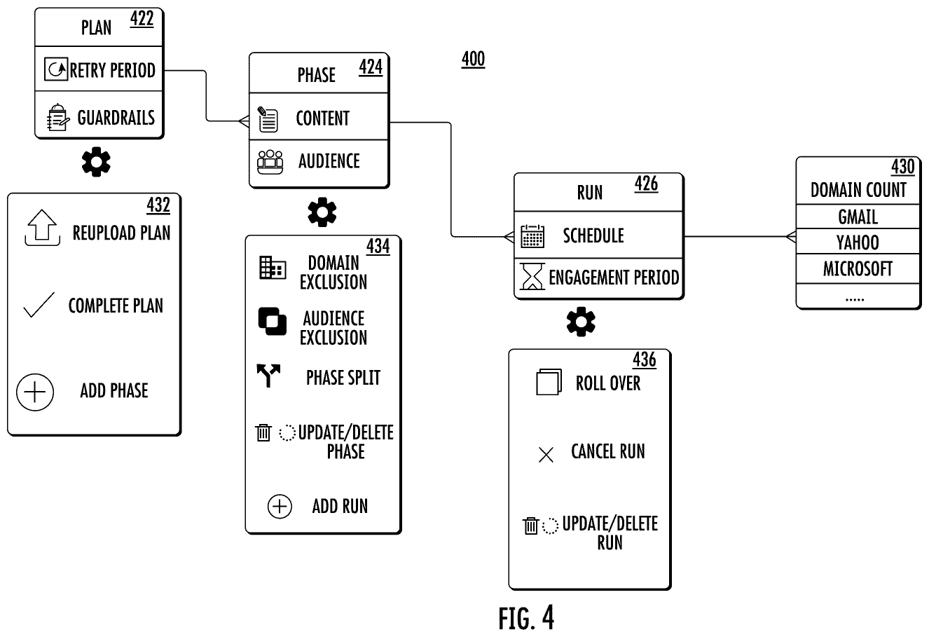

The IP warming plan 210 includes a name 212 for identifying the plan within the IP warming service 105. In some embodiments, the IP warming plan 210 includes one or more phases 214a-n (see FIGS. 4-6). In various embodiments, each phase 214a-n is associated with a different campaign 218a-n, with each campaign defined based on different sets of parameters. Non-limiting examples of campaign parameters include actions for campaign content (e.g., direct message, email, etc.), message content (e.g., the actual content to be sent via the campaign emails), schedules, target audience, and/or the like. In some embodiments, a campaign is retrieved from the stored campaigns 144.

In some embodiments, each phase 214a-n includes one or more runs 218a-n. A run 218a-n includes a scheduled message transmission, for instance, to one or more audience segments (see, for example, FIGS. 4-6 and 9). For instance, a first run includes 5000 email recipients who have purchased product X in the past 90 days, were born after 1980, and have not received a communication as part of the current IP warming plan. The 5000 email recipients are further segmented for the run based on email domain, with 3000 being transmitted to users with a “gmail” email address and 2000 being transmitted to users with a “.outlook” email address. In some embodiments, the audience segments are stored as audiences 146.

FIG. 2A illustrates an example of an IP warming configuration screen according to some embodiments. The screen 204 is configured as a portion of a GUI for a user to interact with an IP warming module, for example, to configure and/or run an IP warming process. In one example, the screen 204 is presented to a user responsive to uploading or defining an IP warming plan (e.g., configured using the screen 202). As shown in FIG. 2B, the IP warming plan includes phases 1-6 (214a-f), each with one or more runs 218. Each run 218 is associated with a send time 233 for starting the run, for instance, performing the actions 235 associated with the run 218, such as sending a batch of targeted emails 220.

Additional configurations can be implemented via the screen 204 for each phase 214, such as excluding profiles from previous runs 230, excluding campaign audiences 231, and/or excluding domain groups 232. In some embodiments, custom domain groups are created by users for use within an IP warming plan. In general, a custom domain group is created by specifying a group of domains, such as a Company A domain group consisting of CompanyA.website1.com, CompanyA.website3.com, and CompanyA.website4.com (i.e., excluding CompanyA.website2.com). In this manner, the IP warming plan and components thereof (e.g., phases 214, runs 218, etc.) are capable of granular targeting of recipient domains. For example, a phase 214 can target X emails for hotmail.com and Y emails for all other Microsoft® email domains (e.g., outlook.com, live.com, msn.com, and/or the like). In some embodiments, custom domain groups provide support for regional service providers, defining combinations of domains on various properties (including non-MX properties), and/or the like.

In various embodiments, domain group mapping is provided, for instance, via a screen the same or similar to screen 204 and/or via upload of a domain group mapping defined in a file. In general, a domain group is a group of domains with the same mail exchange (MX) host belonging to an ISP or ESP. Embodiments provide a list of Global Domain Groups which are provided on available major ISP domains (for instance, Gmail—gmail.com, google.com, googlemail.com; Microsoft—hotmail.com, msn.com, outlook.com, hotmail.co.uk; Yahoo—yahoo.com; and/or the like). Customizations are available to exclude domains from the global domain groups.

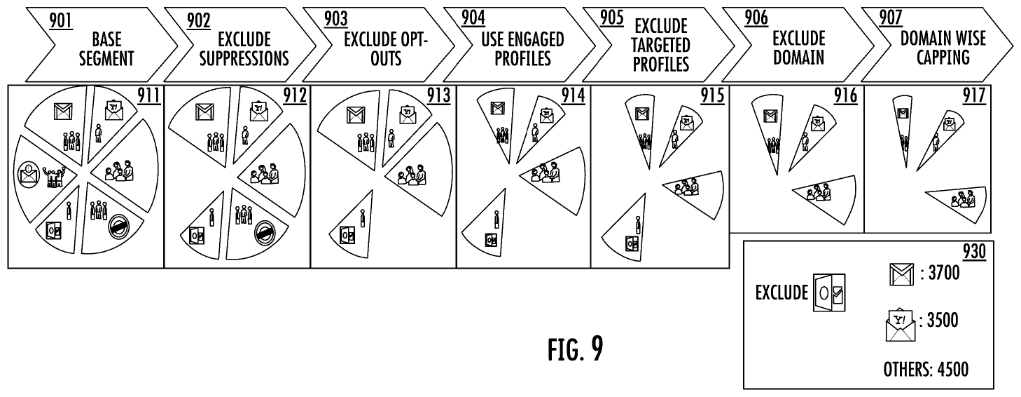

As shown in FIG. 2B, each run can have a specified targeted audience 220, with granular definitions of different domains 221 (“Gmail”) or 222 (“Adobe”). When a run is activated, either automatically based on a schedule or via selection of an activate GUI element 236, a run is initiated (for example, run #1 218a). Once a run is initiated, the IP warming service 105 starts audience creation 125 to build the targeted audience 220a for run #1 218a (see, for example, FIG. 9). The audience 220a may be created according to the parameters of the campaign associated with the phase 214a. For example, the phase 214a may be specified for a campaign targeting owners of a specific brand of automobile and born between 1970 and 1990. In another example, the audience 220a may be configured based on recipient email actions. For instance, the audience 220a is configured to include user email addresses based on a read rate and opt-out rate to create an audience with an overall read rate (or predicted read rate) of over X % and an opt-out rate (or predicted opt-out rate) of less than Y %. The audience 220a may be further segmented based on domain according to the definitions of the IP warming plan into segment 221a for “Gmail” and 222a for “Adobe.”

The IP warming service 105 executes the IP warming plan 130. For example, run #1 218a is executed, sending emails for the associated campaign to the target recipients 220a. During execution of the IP warming plan, metrics, analytics, key performance indicators (KPIs), etc. are generated and/or received. The IP warming service 105 uses the metrics as part of metrics analysis 135. In some embodiments, the metrics analysis 135 operates to modify aspects of a run, phase, plan, audience segmentation, and/or the like.

For example, a rule is defined specifying a certain action if the email bounces are over a threshold (see, for example, FIG. 8). The metrics include the number of email bounces for a run. This metric is evaluated by the rule (for instance, via the rule module 328 of FIG. 3) and the action is applied if the rule is triggered. For example, if the number of bounces is greater than 20%, a new phase is added with a specified domain group.

In another example, a run is split based on the metrics analysis 135. In some embodiments, phases can be split during execution of a run. For example, a new phase can be added from a current phase (splitting the original phase). Runs associated with the original phase after the split are now associated with the new phase. For example, if Phase 1 included Runs 1-3 and Phase 1 was split into Phase 2 after Run 1, then Runs 2 and 3 would be a part of the new Phase 2. In some embodiments, a user can implement a phase split. FIG. 2C depicts a phase split operation. As shown in FIG. 2A, run #1 218a has been split into phase 214a, pushing the remaining runs into new phases. For instance, runs #2 218b and #3 218c have been moved from phase 1 214a to phase 2 214b. New phase 7 214g has been created to hold the runs previously in phase 6 214f.

In a further example, if the actual read rate for emails in Run 1 is below an expected value, the audience segmentation of a subsequent run (Run 2) can be modified to form a target audience with a higher read rate.

FIG. 2D depicts an example of an IP warming metrics screen 208. As shown in FIG. 2D, IP warming metrics screen 208 graphically displays various types of metrics 250a-n that are generated as a result of the IP warming process, such as sending performance 250a, IP warming progress 250b, email statistics 250c, domain-based statistics (e.g., best-performing recipient domains) 250n, and/or the like. In some embodiments, the IP warming progress 205b statistics are estimated based on known IP warming metrics used by a service provider. For instance, historical data indicates that a spam percentage of X % for Service Provider A leads to a reputation score of Y. In another instance, historical data indicates that a deliver error percentage of X % leads to a deduction of Y from a current reputation score. In other embodiments, the IP warming progress 205b statistics are obtained from the service provider. For instance, Service Provider A may share IP warming statistics with users, including a reputation score. These shared statistics may be a data source for the IP warming metrics screen 208.

In some embodiments, the metrics analysis 135 uses computation models, machine learning (ML), artificial intelligence (AI), and/or the like to generate future IP warming plans and/or components thereof (e.g., audience segments, phases, runs, and/or the like). For instance, historical metrics analysis data can be used as training data to train an AI/ML model to learn factors for achieving IP warming success. In one example, an AI/ML model can be trained using the training data to learn the requirements of various service providers for IP warming. In a further example, an AI/ML model can be trained using the training data to learn the effect of email actions (e.g., bounces, unsubscribe requests, etc.) on reputation indicators. For instance, for a first service provider, email bounces effect the reputation score more than unread messages. Accordingly, an audience segment or an IP warming plan can be configured for that particular service provider that is biased toward potential unread messages versus email bounces. In an additional example, an AI/ML model can be trained using the training data to make engagement predictions, for example, predicting target user or audience read rates, opt-out rates, suppression rates, engagement rates, and/or the like based, at least in part, on historical data. Embodiments are not limited in this context.

FIG. 3 illustrates an example embodiment of a system 300 that performs the operations discussed herein. The system 300 includes additional systems and computing components to perform various operations. In one example, the system 300 includes a content distribution system 310 including components or modules to perform operations for distributing communications or other content and for performing an IP warming process. In one embodiment, these modules include an IP warming module 320 and a distribution module 340. In some embodiments, the IP warming module 320 includes one or more modules, including a plan module 322, a phase module 324, a run module 326, and a rule module 328. Each of the modules performs one or more operations to perform an IP warming process according to embodiments.

The system 300 includes a service provider 350 configured to communicate with the content distribution system 310, for example, via a network 306, which includes, without limitation, one or more local area networks (LANs), wide area networks (WANs), the internet, a wired or wireless network, and/or the like. Each of the service provider 350 and the content distribution system 310 shown in FIG. 3 can comprise one or more computer devices. The service provider 350 performs one or more types of services to facilitate communication over a network with one or more user devices 370a-n. Non-limiting examples of a service provider 350 include an ISP, an ESP, an MBP, a cloud-computing system, a data center, a social media provider, a content-sharing provider, and/or the like.

It should be understood that any number of user devices 370a-n, service provider 350, and/or content distribution systems 310 may be employed in the system 300 within the scope of the present disclosure. Each of the user devices 370a-n, service provider 350, and/or content distribution system 310 may comprise a single device or multiple devices cooperating in a distributed environment. For instance, the content distribution system 310 could be provided by multiple server devices collectively providing the functionality of the content distribution system 310 as described in the present disclosure. Additionally, other components not shown may also be included within the environment of network 306.

The user devices 370a-n can be any type of computing device, such as, for instance, a personal computer (PC), tablet computer, desktop computer, mobile device, smartphone, tablet device, or any other suitable device having one or more processors. The user devices 370a-n may execute one or more applications for interacting with the service provider 350 and/or a distribution application 360 of the service provider 350. In one example, the service provider 350 is an ESP and the distribution application 360 is an email application. The user devices 370a-n send and receive email, and perform other email functions, through the service provider 350 via an application, a web browser, and/or the like.

In some embodiments, the content distribution system 310 is integrated into a content management platform. In various embodiments, the IP warming module 320 is integrated into a content management platform. A non-limiting example of a content management platform is the Adobe® Journey Optimizer application provided by Adobe® Inc., San Jose, California, United States of America. For example, a content management platform can provide a feature for generating a content distribution campaign (e.g., an email marketing campaign). The management platform can include an IP warming campaign feature configured according to some embodiments. Various types of campaigns can be used according to some embodiments, including, without limitation, email campaigns, in-app messages, text messages, and/or the like.

In some embodiments, the distribution module 340 operates to distribute content. For example, the distribution module 340 operates to send emails to the user devices 370a-n via the service provider 350. In one example, the distribution module 340 is an email application executed on the content distribution system 310 to transmit emails from a marketing campaign. In another example, the distribution module 340 is an enterprise software platform such as a marketing campaign application (e.g., Adobe® Journey Optimizer), a customer relationship management (CRM) application (e.g., Salesforce®, SAP®, and/or the like), a communication platform (e.g., Twilio®), and/or the like. The distribution module 340 may be associated with one or more IP addresses for sending communications that require IP warming performed by the service provider 350.

In various embodiments, the distribution application 360 executed by the service provider 350 includes a monitoring application 362. The monitoring application 362 is configured to monitor various aspects of the distribution, publishing, transmission, or other functions of content serviced by the service provider 350. For example, for an ESP service provider 350, the monitoring application 362 monitors various aspects of email activity routed to user devices 370a-n via the service provider 350. In one example, for each sender or IP address, the monitoring application 362 monitors the volume of communications (e.g., X emails/time period), the nature of the communications (e.g., marketing emails, educational emails, email content (e.g., graphics, text, video)), email properties (e.g., size, length), recipient emails (e.g., personal emails, business emails, and/or the like), and/or any other type of discernable property of communications sent by the content distribution system 310. In another example, the monitoring application 362 monitors sending patterns to discern deliverability problems, such as potential spam email patterns.

The monitoring application 362 stores historical information or distribution metrics for each sender and/or IP address. The historical information can indicate typical communication volume and volume patterns, communication recipients and/or addresses, communication address lists, engagement levels and/or rates (e.g., clicks, reads, opt-outs, suppressions, and/or the like), and/or any other type of information used by service providers to evaluate, monitor, and determine sender reputations. For example, the historical information can indicate that Sender A has had a click rate of 70% for emails during the past 30 days, which increased from a click rate of 65% over the previous 60 days.

In another example, the monitoring application 362 monitors recipient activity with the emails, including, without limitation, bounce backs (e.g., incorrect or non-existent email addresses), email deletion, email folder movement (e.g., movement to spam/junk, archive, special folders, and/or the like), user unsubscribing activity, opt-outs, and/or the like. The monitoring application 362 operates to evaluate the reception of emails by users served by the service provider 350. In some examples, the monitoring application 362 records the recipient activity with content, communications, emails, and/or the like. The recipient activity is recorded as metrics. The metrics are configured to provide an indication of the quality, value, usefulness, and/or the like of distributed content. Non-limiting examples of metrics include bounces, undeliverable notices, spam events, unsubscribe requests, opt-outs, and/or the like. In some embodiments, the metrics are stored as historical information for the corresponding sender. For example, the metrics can be saved as metrics 148 and used by the metrics analysis 135 service, for instance, for training an AI/ML model to make predictions of IP warming progress.

The volume management application 364 is configured to provide functions associated with managing the volume of content distributed via the service provider 350. The volume management application 364 operates to block, flag, throttle, permit, allow, and/or otherwise manage content. For example, if the distribution metrics (for instance, determined via the monitoring application 362) indicate that certain emails are spam/junk, the volume management application 364 blocks (or throttles) messages from the IP address associated with the spam/junk emails. In another example, if the distribution metrics indicate that an IP address is associated with non-spam/junk content, the volume management application 364 allows the emails to be sent to the intended recipients at a desired volume. In a further example, if the distribution metrics indicate an unusual spike in email volume from a certain IP address, the volume management application 364 blocks the ability to send emails from this IP address, designates the emails from this IP address as spam, or throttles the volume of email from the IP address to a threshold volume until the service provider 350 has updated the reputation indicator for the sender through IP warming.

In various embodiments, the volume management application 364 is executed by a service provider 350. The volume management application 364 allows the service provider 350 to control the communications distributed by the service provider 350. For example, the volume management application 350 can allow the service provider to track IP address reputation scores, throttle email, tag email as spam, and/or the like. The IP warming services of the service provider can be implemented through the volume management application.

In one example, the volume management application 364 maintains a reputation score or other reputation indicator for each IP address that is used to distribute content via the service provider 350. The volume management application 365 performs IP warming according to the guidelines, rules, and/or the like maintained by the service provider 350. For example, the IP warming may be expected to occur over a certain duration (for instance, seven to ten weeks). In another example, the IP warming may be expected to include a certain schedule or ramp-up of email volume (for instance, starting at 5,000 emails/week and ramping up by a certain rate each week). In another example, the IP warming may be expected to focus on certain factors (which may be weighted), such as email deletion, suppression, read rate, open rate, click rate, and/or the like. Once the service provider IP warming is complete, the content distribution system 310 is able to send emails at or above an established threshold volume from the warmed IP address via the service provider 350.

As shown in FIG. 3, the content distribution system 310 includes an IP warming module 320. The IP warming module 320 is executed by the content distribution system 310 to perform an IP warming process, for example, to warm up an IP address used by the content distribution system 310 to send communications via the service provider 350.

In some embodiments, the IP warming module 320 operates using a schema that includes three hierarchical levels: a plan level, a phase level, and a run level. The plan level is implemented by the plan module 322 and is configured as the foundational level of the IP warming schema, representing an overarching strategy for IP warming. In some embodiments, plans comprise multiple phases and configurations, serving as the blueprint for an IP warming process. In various embodiments, phases are implemented by the phase module 324 and are configured as intermediate levels within the IP warming schema, representing specific stages or milestones within an IP warming process or journey. Phases allow for operations such as splitting, adding, or deleting, enabling dynamic management and optimization. In some embodiments, the run level is implemented by the run module 326 and is an operational level of the IP warming schema, encompassing individual executions of the IP warming process (e.g., sending batches of emails to recipient email addresses of a target audience). Runs are associated with specific domains and schedules, facilitating targeted engagement and evaluation of performance metrics.

In some embodiments, the IP warming module 320 includes an audience orchestration module 330 configured to generate, segment, or otherwise create one or more audiences and/or audience segments for an IP warming process (see, for example, FIG. 9). The audience orchestration module 330 may be triggered by the IP warming module 320 responsive to determining that a run has been initiated. For instance, in some embodiments, a new audience is created for each run. The audience orchestration module 330 operates to generate a new audience for the run based on the audience definitions for the campaign associated with the phase of the run and any factors defined for the run. For example, an engagement factor may be defined for the run specifying that audience email addresses are to be associated with users that have made a purchase via a specific e-commerce website within the past 30 days. In another example, an engagement factor may be defined for the run specifying that audience email addresses are to be associated with users that have read an email from the sender within the past 90 days.

The IP warming module 320 operates to execute the plan module 322 for generating IP warming plans according to some embodiments. Responsive to creating an IP warming plan, the phase module 324 is used to create and configure phases for the plan module 322. The run module 326 is executed by the IP warming module 320 when creating runs for each phase generated by the phase module 324. The IP warming module 320 also calls the run module 326 to make modifications to a run.

The IP warming module 320 operates to execute an IP warming plan according to some embodiments. When a run is initiated, the IP warming module 320 executes the audience orchestration module 330 to create the audience for the run. The distribution module 340 is used by the IP warming module 320 to transmit the emails for the run via network 306 to service provider 350 and, ultimately, to user devices 370a-n. During execution of the IP warming plan, the rule module 328 accesses metrics for the batch of emails. Non-limiting examples of metrics include read rates, delete rates, bounces, spam activity, and/or the like. If a rule is triggered, the rule module 328 may transmit a signal to the IP warming module 320 to take the action associated with the rule. For instance, the rule module 328 may transmit information for the IP warming module 320 to change the domain split for a run. The IP warming module 320 may trigger the run module 326 to make the change to the domain split for the next run.

FIG. 4 illustrates an example of an IP warming schema in accordance with embodiments described in the present disclosure. As shown in FIG. 4, an IP warming schema 400 includes a plan level 422, a phase level 424, and a run level 426. The plan level 422 includes multiple features, including a retry period and guardrails. In some embodiments, the retry period provides settings for repeating or revising the plan 422. In various embodiments, the guardrails include one or more performance guardrails or performance limits for the plan. Non-limiting examples of performance guardrails include communication limits, such as a peak volume-number of emails per time period (e.g., 15,000 emails per hour), peak volume-transactional messaging, peak volume-number of push notifications, maximum batch email size, maximum inbound interactions, and/or the like. In various embodiments, each phase plan 422 includes multiple functions 432 such as re-upload plan, complete plan, and add phase.

In some embodiments, the plan level 422 includes one or more phases or phase levels 424. Each phase 424 can include various features, such as content (e.g., the content of the communication) and an audience (e.g., one or more audience or audience segments that serve as communication recipients).

In various embodiments, each phase 424 includes one or more runs 426. Each run 426 defines a batch of emails to be sent over a particular duration. A duration may include one day. Accordingly, each run 426 can be configured to define a batch of emails to be transmitted each day. In some embodiments, each run 426 is defined based on one or more features. One feature is a schedule feature specifying the timing for sending the emails. Another feature includes an engagement period, for instance, defining engagement of users for the specified audience. In various embodiments, each run 426 includes multiple functions 436. An example function 436 is a roll over function to roll over the audience and/or emails to a subsequent run. Another example function is a cancel run function to cancel an active run. An additional example function is a delete function to delete an upcoming, inactive run. A further function is an update run function to update one or more features of a run, such as the timing and/or engagement parameters. In some embodiments, each run 426 is associated with a domain count 430. The domain count 430 specifies the number of emails to be sent to specific domains. For instance, a domain count 430 specifics that 3,000 emails are to be sent to Gmail® and 2,000 emails are to be sent to Microsoft®.

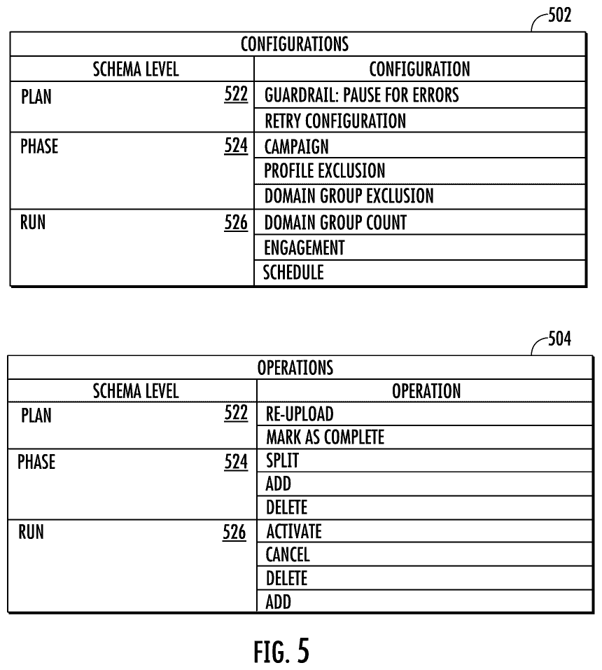

FIG. 5 illustrates an example of configuration profiles for an IP warming schema in accordance with embodiments described in the present disclosure. In various embodiments, one or more graphical user interfaces (GUIs) are available through IP warming module 320 (IP warming GUIs) to allow users to create, configure, build, change, or otherwise enter one or more configurations 502 and/or operations 504 for each schema level.

In various embodiments, at the plan level 522, configurations 502 are available for automatically pausing on guardrail errors or retrying one or more configurations. In some embodiments, at the plan level 522, operations 504 are available to re-upload a plan and/or to mark a plan as complete.

At the phase level 524, configurations 502 are available for configuring a campaign (e.g., an email campaign) to be used for the IP warming process, profile exclusion (e.g., exclude a certain audience profile from the IP warming process, or domain group exclusion (e.g., exclude Microsoft or CompanyName.com email addresses). In some embodiments, at the phase level 524, operations 504 are available to split, add, or delete a phase.

In some embodiments, at the run level 526, configurations 502 are available for recipient domain group count (e.g., specifying the number of recipients for particular domain(s)), engagement (e.g., specifying the type of engagement for the run of the IP warming process), and schedule. In some embodiments, at the run level 526, operations 504 are available to activate, cancel, delete, or add a run. In some embodiments, each phase 524 is composed of several runs 526, to which a single campaign is assigned.

FIG. 6 illustrates an example of an IP warming plan in accordance with embodiments described in the present disclosure. As shown in FIG. 6, in some embodiments, an IP warming plan 610 includes a plurality of phases 611, each phase 611 with multiple runs of communications for one or more recipient domains 613. In plan 610, each run 612 represents a different day to be executed for the plan 610. Runs 612 include a different volume of emails and a different split among the domains 613. In some embodiments, the IP warming plan 610 is created and/or saved in a file, such as a spreadsheet, comma separated values (CSV) file, a Microsoft® Excel® file, text file, and/or the like. In various embodiments, the IP warming plan 610 is saved, uploaded, modified, or otherwise interacted with by a user via an IP warming GUI according to various embodiments.

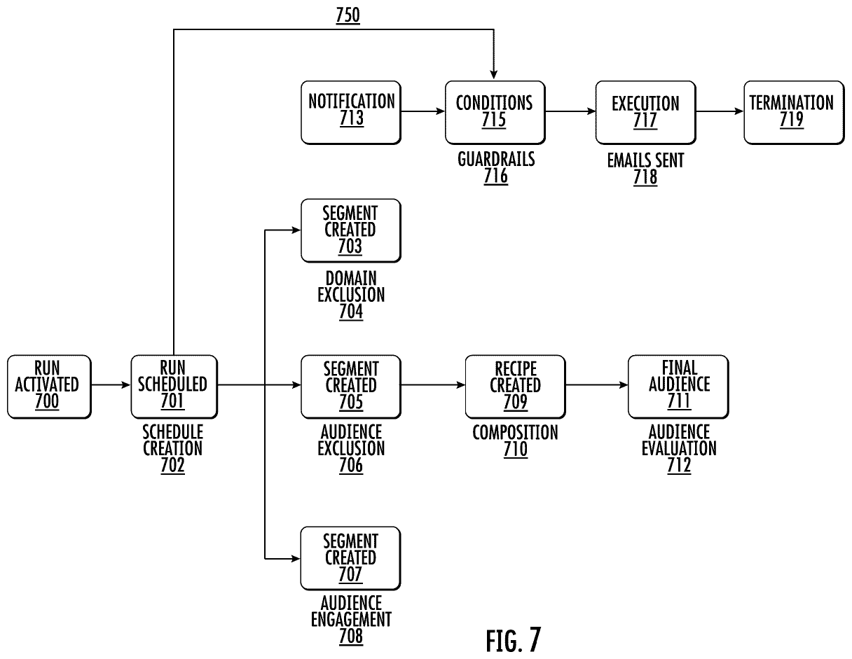

In some embodiments, the schema of an IP warming plan is compiled into an execution context, such as a graph. This execution context operates to orchestrate the IP warming process, for instance, orchestrating segment evaluation, audience composition, and last-mile email delivery. FIG. 7 illustrates an example of an IP warming graph in accordance with embodiments described in the present disclosure. As shown in FIG. 7, a graph 750 is initiated by activating a run 700 of a scheduled run 701. The scheduled run 701 is created during schedule creation 702. The scheduled run 701 involves one or more created segments 703, 705, and 707. For example, the segment 703 is created via domain exclusion 704, for example, specifying which recipient domains to include and exclude from the run. The segment 705 is created by audience exclusion 706 (see, for instance, FIG. 9), for example, by specifying which audience segments to include and exclude from the run (e.g., audience members with a read rate or predicted read rate over X %). The segment 707 is created by audience engagement segmentation 708 (see, for instance, FIG. 9), for example, by including or excluding audience segments based on their engagement with sender communications, websites, platforms, or other entity properties. For instance, the segment 707 can include portions of an audience that recently made an online purchase, signed up for emails, opened sender emails, and/or the like. In various embodiments, the audience segment 705 created via audience exclusion 706 is further defined via recipe creation 709, for instance, a recipe or set of criteria for selecting audience members, and final audience 711 determination using audience evaluation 712.

In some embodiments, the scheduled run 701 is evaluated based on various conditions 715. In various embodiments, a condition 715 includes or is associated with guardrails 716. In some embodiments, a guardrail 716 is a threshold for a condition. Non-limiting examples of performance guardrails 716 include communication limits, such as a peak volume-number of emails per time period, peak volume-transactional messaging, peak volume-number of push notifications, maximum batch email size, maximum inbound interactions, and/or the like. For example, the email batch size for a run cannot exceed the maximum batch email size. Accordingly, when creating a run, a user is not able to specify an email batch size over the maximum batch email size. In another example, if the peak volume-number of emails per time period guardrail is met, the currently active run is stopped.

In some embodiments, the conditions 715 include one or more rules. In some embodiments, the rules are defined in the rule module 328 of the IP warming module 320. The rule module 328 is configured to implement rule-based decision making within the IP warming process. Rule module 328 enables execution of predefined actions based on specified conditions for a run.

In some embodiments, in general, a rule has the form: if <distribution metric> is >/</=to a threshold, perform <change/action>. In some embodiments, rules are user-defined. In other embodiments, default rules are defined upon creation of a warmup plan. One non-limiting example of a rule defines that if the bounce rate for a specific domain group exceeds x %, the system automatically initiates a split phase operation and adds that domain group to a domain exclusion list for the new phase. Accordingly, some embodiments facilitate a proactive approach that ensures timely intervention in response to emerging issues, thereby eliminating the need for manual intervention and mitigating possible delays.

FIG. 8 illustrates an example of rules or conditions configured using the rule module 328 in accordance with embodiments described in the present disclosure. As shown in FIG. 8, conditions or rules include various conditions and associated actions. For example, conditions 810 and 811 provide rules for managing different spam event percentages. In another example condition 812 provides a rule for managing a total IP warming limit. Actions or operations 820 are defined for each of conditions 810-712. For example, responsive to condition 810, operation 821 is performed (operation_split(exclusion_domain_groups) to execute a split for excluded domain groups, for instance). In another example, responsive to condition 811, operation 822 is performed (operation_reupload(warmup_plan_file) to reupload a warmup plan, for instance. In a further example, responsive to condition 812, operation 823 is performed (add_phase(campaign_id, audience_id, domain_groups_count) to add a phase to a current run, for instance.

Referring to FIG. 7, in some embodiments, one or more notifications 713 are triggered, such as a timestamp or other information associated with the conditions 715. The run is executed 717, for example, emails are sent 718 as part of the run for the IP warming process. Once the process is complete, the run is terminated 719.

Some embodiments include processes for audience targeting in each run that is dynamically optimized based on parameters such as engagement, consent, and exclusion criteria. This optimization provides a bias towards IP warming intricacies (as opposed to, for instance, traditional marketing-based audience segmentation) that ensures peak deliverability and engagement outcomes.

FIG. 9 illustrates an example of a processing flow for IP warming audience creation in accordance with embodiments described in the present disclosure. In some embodiments, the processing flow of FIG. 9 is performed via audience orchestration module 330 of IP warming module 320.

As shown in FIG. 9, a base audience selection step 901 determines a base audience 911. For example, the base audience includes a mailing list for an entity. In another example, the base audience is an audience configured for an email marketing campaign. For instance, the campaign may target users who use a certain enterprise software platform. In some embodiments, the campaign includes content defining emails to be sent as part of the campaign. In various embodiments, the campaign includes a list of users (or user email addresses) that are to be targeted as part of the campaign. In some embodiments, the campaign is a campaign selected for a specific phase of an IP warming plan. During an exclude suppressions step 902, recipients that have been associated with suppressions, such as opt-outs, unsubscribing, etc. are removed from base audience 911 to form audience 912. At step 903, opt-outs are removed to create audience 913. Engaged profiles are selected at step 904 to create an audience 914 that consists of members of audience 913 that meet certain engagement profiles (e.g., have engaged in the last 30 days, threshold engagement percentage, purchases, website visits, app usage, read rates, and/or the like). At step 905, targeted profiles are excluded to create audience 915. In some embodiments, the audience 916 is created by segmenting audience 915 based on domains, for instance, by excluding certain domains at step 906. For instance, the outlook.com domain can be excluded. At step 907, step-wise capping can be implemented to determine final audience 917. Step-wise capping 930 can be defined by capping the number of audience members for certain domains at a domain limit.

In some embodiments, the selection criteria used to form any of audiences 912, 913, 914, 915, 916, and/or 917 may be defined within a run. For example, a campaign may be selected for a phase that includes a base audience 911 of all users that have purchased Product X in the past year. A run may be defined for the phase that specifies exclusion of base audience members that do not meet certain engagement criteria (e.g., opt-out rate, read rate, and/or the like).

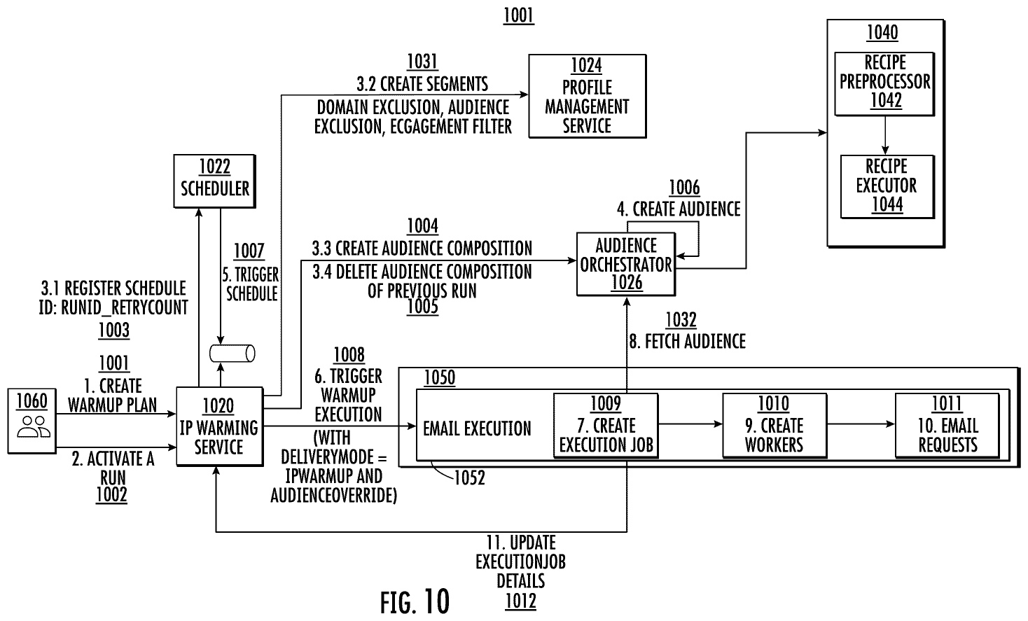

FIG. 10 illustrates an example of an IP warming architecture in accordance with embodiments described in the present disclosure. As shown in FIG. 10, an IP warming architecture 1000 is defined for implementing an IP warming process within a campaign platform, for instance, Adobe® Journey Optimizer.

In the example of FIG. 10, the IP warming architecture 1000 receives a warmup plan 1001 created by a user 1060 and activates a run 1002 according to various embodiments. Activation of the run 1002 starts an IP warming service 1020 executed, for example, via the IP warming module 320. The schedule associated with the run is registered 1003, for example, with a scheduler 1022 (for instance, customer journey manager (CJM) or CJM scheduler in Adobe® Journey Optimizer) and is triggered 1007 by the scheduler 1022.

The IP warming service 1020 creates audience segments 1031, for instance, via domain exclusion, audience exclusion, engagement filters, and/or the like (see, for example, FIG. 10). The audience segments 1031 are provided to a profile management service 1024. In some embodiments, the IP warming service 1020 operates to create an audience composition 1004 (and, if necessary, delete 1005 audience compositions of previous runs). An audience orchestrator 1026 (for example, audience orchestration module 328) operates to create an audience 1006. In some embodiments, the audience orchestrator 1026 uses various modules 1040 to create the audience, such as an audience recipe pre-processor 1042 and/or a recipe executor 1044.

Execution of the IP warming process is triggered 1008, initiating a message runtime process 1050. In some embodiments, the message runtime process 1050 operates email execution or an email execution service 1052 which creates execution jobs 1009. The email execution service 1052 accesses the audience 1032 and execution job details 1012 (for instance, run details, configurations, and/or the like). The email execution service 1052 creates message execution workers 1010 operative to email recipients via email requests 1011.

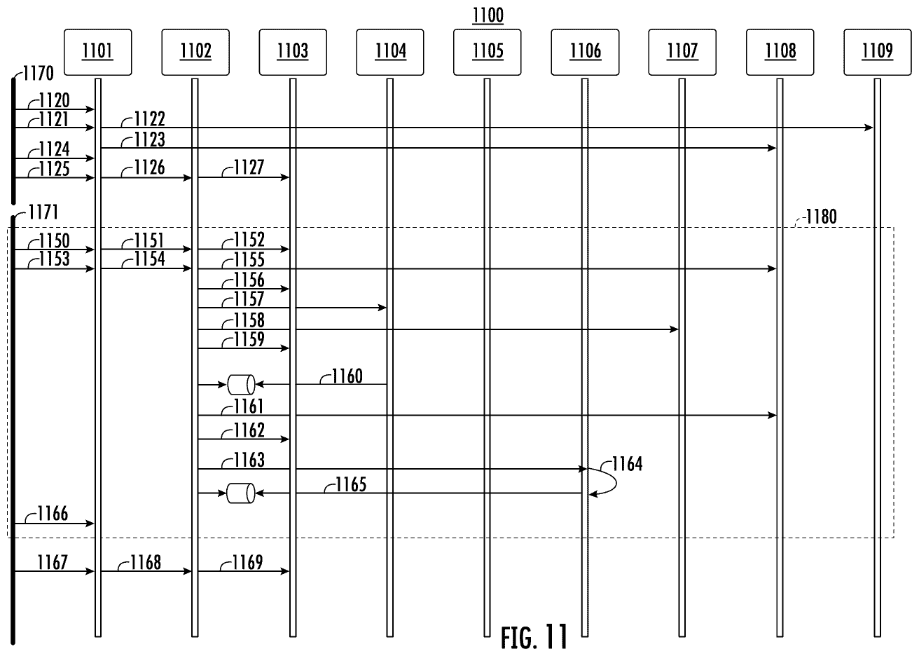

FIG. 11 illustrates an example of a process flow for an IP warming process in accordance with embodiments described in the present disclosure. In some embodiments, processing flow 1100 is performed in whole or in part by the IP warming module 320.

As shown in FIG. 11, an IP warming process 1100 includes various modules including an IP warming GUI 1101, an IP warming service 1102, an IP warming service database 1103, a campaign or journey manager 1104, a message execution service 1105, a message runtime resource manager 1106, a message presets service 1107, an audience orchestrator 1108, and a campaign platform 1109. Certain steps of the IP warming process 1100 are performed by a user 1170, for instance, via a GUI of the IP warming module 320. Certain steps of the IP warming process 1100 are performed automatically by the IP warming application 1171.

At step 1120, a user can update a warmup plan, which can include specifying or updating phase details 1121, thereby creating an IP warming email campaign 1122. The user 1170 can select an audience 1123 and update iteration details 1124. The IP warming project can be saved 1125, created in a draft state 1126, and saved 1127, for instance, in a database associated with the IP warming module 320.

The IP warming application 1171 can create or update an IP warming phase or iteration 1150 (if a new phase or iteration is required), update the warming project 1151, and update/save the warming project in the database 1152. A warming iteration is scheduled 1153 and 1154. At step 1155, an audience orchestrator recipe is created per plan for the iteration. For example, an audience identifier can be saved 1156 from the previous call, iteration, run, etc.

A warming schedule is created 1157 and preset and IP pool status is updated 1158 (so they cannot be edited). The warming process status is updated to active if the first iteration and the iteration status is changed to scheduled 1160. The audience refresh status is checked 1161. The IP warming iteration is triggered according to the schedule 1162, the audience refreshed status is checked 1163, and the iteration schedule is changed to triggered 1164. Campaigns or projects with a delivery mode set to IP warming are posted 1163, the IP warming workflow is created, and started 1164, followed by updating of the iteration status 1165. Reports from the IP warming process can be reviewed, and the next iteration scheduled 1166. In some embodiments, steps 1150-1166 can be looped or repeated until the IP warming process is complete or otherwise is stopped.

At step 1167, the status of the IP warming process (or portion thereof, such as a run or phase) is marked complete and a status is provided. Non-limiting examples of a status include a success indicator, a failure indicator, and/or the like. The IP warming process status is updated 1168 and, in some embodiments, is updated in the database 1169.

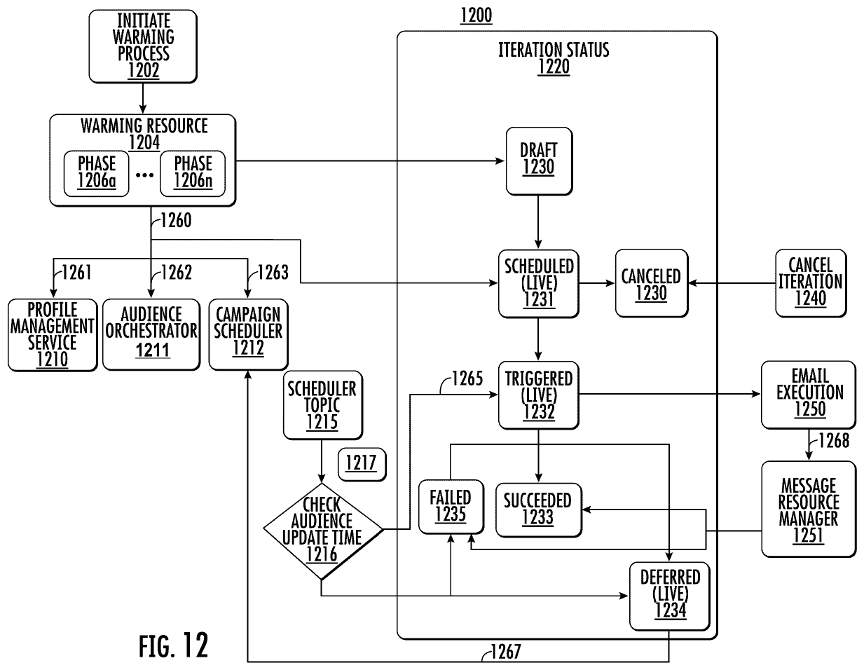

FIG. 12 illustrates an example of a processing flow of an IP warming process within a message runtime resource manager architecture in accordance with embodiments described in the present disclosure. In some embodiments, processing flow 1200 is performed in whole or in part by the IP warming module 320.

As shown in FIG. 12, the processing flow 1200 includes initiating a warmup process 1202, which triggers warming resources 1204, such as warming process phases 1206a-n, and an iteration is scheduled 1260. Audience segments are created 1261 for a profile management service 1210. A plan-specific audience orchestration is created 1262 for an audience orchestrator 1211 and a schedule is triggered 1263 by a campaign or journey manager 1212. The campaign manager 1212 operates to schedule the iteration 1267.

Within the iteration status 1220, the status is changed to draft 1230, and then to scheduled (live) 1231 once active and live. Responsive to the iteration being triggered, the status is updated to triggered (live) 1232. An email execution service 1250 operates to create an execution job workflow 1268 for a message resource manager 1251. The message resource manager 1251 operates to update an iteration status for the iteration. The result of the iteration is determined, for instance, as a success 1233, failure 1235, or deferred (live) 1234.

A scheduler topic 1215 determines an audience update time 1216. If the update duration (or epoch) is greater than the last iteration finish time, the status is changed to triggered (live) 1232, if not, then the status is changed to failed 1235 if a retry function is disabled or a retry threshold has been reached, or to deferred (live) 1234 if the retry function is enabled and the retry threshold has not been reached.

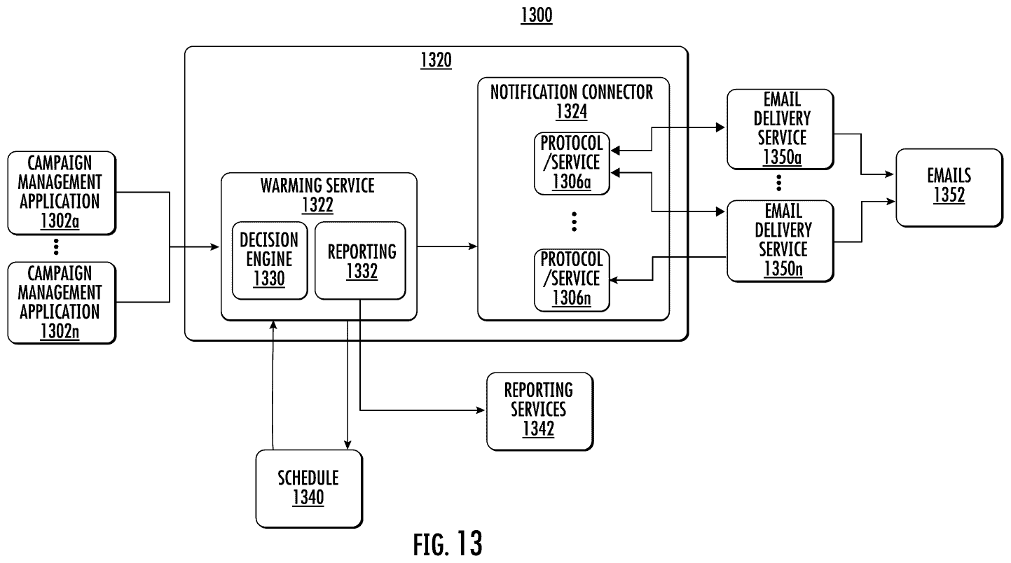

FIG. 13 illustrates an example of an IP warming architecture in accordance with embodiments described in the present disclosure. In some embodiments, architecture 1300 includes IP warming module 320 and/or functions performed via IP warming module 320.

As shown in FIG. 13, IP warming architecture 1300 can receive input from multiple different campaign management applications 1302a-n. For example, one of campaign management applications 1302a can be the Adobe® Journey Optimizer application, while campaign management applications 1302n are one or more different types of application. Accordingly, the IP warming module 320 is able to operate using campaigns and other input from multiple different applications. For example, the architecture 1300 can operate as a computing service 1320, such as a cloud computing service, X-as-a Service (XaaS) (e.g., IP warming-as-a-Service), and/or the like.

Within the computing service 1320 operates a warming service 1326 that receives information, campaigns, etc. from the campaign management applications 1302a-n for generating IP warming campaigns. The warming service 1322 includes a decision engine 1330 for determining various aspects of an IP warming campaign based on the information received from the campaign management applications 1302a-n.

The warming service 1322 can schedule 1340 the IP warming process and receive feedback. In some embodiments, reporting services 1342 are provided via a reporting engine 1332 of the warming service 1322. In various embodiments, results of the warming campaign are provided via a GUI. In some embodiments, a notification connector 1324 provides one or more protocols/services 1306a-n, such as email delivery services 1350a-n for the delivery of emails 1352 as part of the IP warming process.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

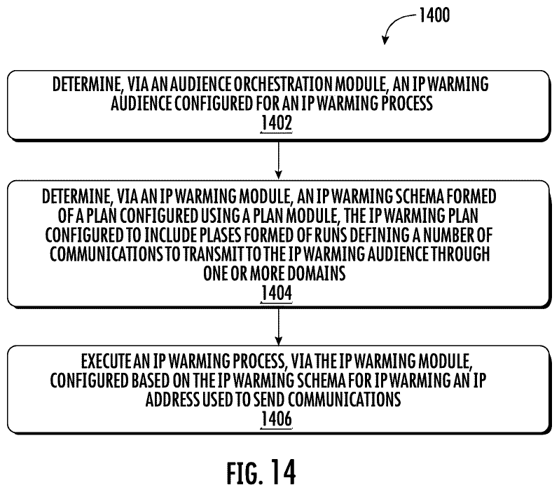

FIGS. 14-16 illustrate embodiments of a logic flow 1400, 1500, and 1600. The logic flows 1400, 1500, and 1600 are representative of some or all of the operations executed by one or more embodiments described herein, for example, for creating and executing an IP warming process according to some embodiments. For example, the logic flows 1400, 1500, and 1600 include some or all of the operations performed by devices or entities within the system 100 or 300 as described herein.

Referring to FIG. 14, in block 1402, the logic flow 1400 includes determining, via an audience orchestration module, an IP warming audience configured for an IP warming process. For example, audience orchestration module 330 operates to generate a final audience 917 from a base audience 911 associated with a campaign. The audience orchestration module 330 operates to generate a final audience 917 based on a campaign associated with a phase of an IP warming plan. In another example, when a run of an active phase is initiated, the IP warming service 105 starts audience creation 125 to build the targeted audience 220a for run #1 218a (see, for example, FIG. 9). The audience 220a may be created according to the parameters of the campaign associated with the phase 214a. For example, the phase 214a may be specified for a campaign targeting owners of a specific brand of automobile and born between 1970 and 1990. The audience 220a may be further segmented based on domain according to the definitions of the IP warming plan into segment 221a for “Gmail” and 222 a for “Adobe.” The audience 220a may be further segmented based on metrics associated with IP warming, such as read rates, opt-out rates, and/or the like to specifically configure the audience for IP warming goals.

In block 1404, the logic flow 1400 includes determining, via an IP warming module, an IP warming schema formed of a plan configured using a plan module, the IP warming plan is configured to include phases formed of runs defining a number of communications to transmit to the IP warming audience through one or more domains. For example, the IP warming module 320 is used to generate or access a generated IP warming schema, for instance, via IP warming plan screen 202. The IP warming schema can be formed of a plan with various levels, such as a plan level, a phase level, and a run level (see, for example, FIGS. 2A and 4).

In block 1406, the logic flow 1400 includes executing an IP warming process. The IP warming process is performed by the IP warming module configured according to some embodiments. For example, the IP warming module 320 operates to execute an IP warming plan. Execution of the IP warming plan includes performing each phase and run defined within the plan. In some embodiments, the IP warming module 320 is executed via an IP warming service 105 to perform the IP warming process 130. Execution of an IP warming process includes performing runs to send batches of communications to recipients defined according to the IP warming audience.

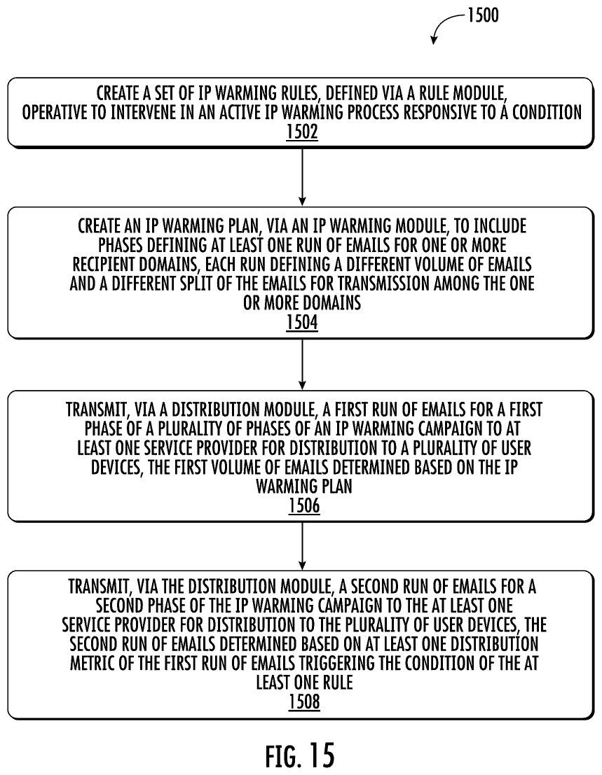

Referring to FIG. 15, in block 1502, the logic flow 1500 creates a set of IP warming rules, defined via a rule module, operative to intervene in an active IP warming process responsive to a condition. For example, rule module 328 is used to generate one or more rules for dynamically managing an IP warming plan, or a component thereof (such as a run, phase, and/or the like). In some embodiments, a rule has the form: if <distribution metric> is >/</=to a threshold, perform <change/action>. One non-limiting example of a rule involves a user-defined rule stating that if the bounce rate for a specific domain group exceeds x %, the system automatically initiates a split phase operation and adds that domain group to a domain exclusion list for the new phase.

In block 1504, the logic flow 1500 creates an IP warming plan, via an IP warming module, to include phases defining at least one run of emails for one or more recipient domains, each run defining a different volume of emails and a different split of the emails for transmission among the one or more domains. For example, the IP warming module 320 is used to generate or access a generated IP warming plan, for instance, via IP warming plan screen 202. In some embodiments, an IP warming plan 610 includes a plurality of phases 611, each phase 611 with multiple runs of communications for one or more recipient domains 613. In plan 610, each run 612 represents a different day to be executed for the plan 610. Runs 612 include a different volume of emails and a different split among the domains 613.

In block 1506, the logic flow 1500 transmits, via a distribution module, a first run of emails for a first phase of a plurality of phases of an IP warming campaign to at least one service provider for distribution to a plurality of user devices, the first volume of emails determined based on the IP warming plan. For example, the distribution module 340 operates to transmit communications according to an IP warming plan (for instance, targeted emails 220a of the warming plan depicted in FIG. 2B).

In block 1508, the logic flow 1500 transmits, via the distribution module, a second run of emails for a second phase of the IP warming campaign to the at least one service provider for distribution to the plurality of user devices, the second run of emails determined based on at least one distribution metric of the first run of emails triggering the condition of the at least one rule. For example, an IP warming service 105 performs metrics analysis 135 based on various metrics of a batch of emails sent as part of an IP warming plan run, such as bounce rate, read rate, deletion rate, and/or the like. The metrics analysis 135 operates to analyze the metrics and modify the IP warming plan accordingly, for instance, based on one or more rules 810-812. The metrics analysis 135 can operate to modify the email volume and/or email distribution of an existing run and/or a future run.

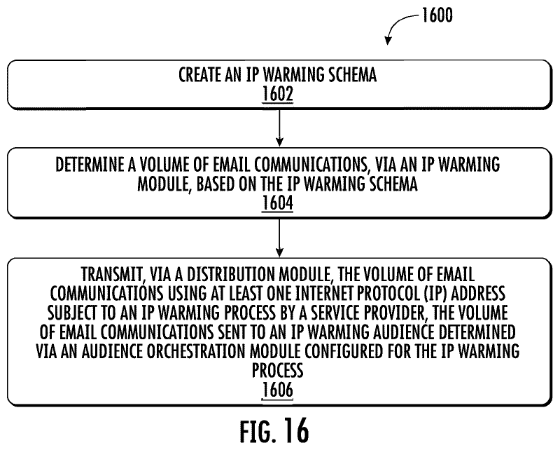

Referring to FIG. 16, in block 1602, the logic flow 1600 creates an IP warming schema. For example, the IP warming module 320 is used to generate or access a generated IP warming schema, for instance, via IP warming plan screen 202. The IP warming schema can be formed of a plan with various levels, such as a plan level, a phase level, and a run level (see, for example, FIGS. 2A and 4).

In block 1604, the logic flow 1600 determines a volume of email communications, via an IP warming module, based on the IP warming schema. For example, the volume of emails is based on the targeted emails (e.g., emails 220a of FIG. 2B) of an active run. In some embodiments, the distribution module 340 operates to transmit communications according to an IP warming plan (for instance, targeted emails 220a of the warming plan depicted in FIG. 2B).

In block 1606, the logic flow 1600 transmits, via a distribution module, the volume of emails communications using at least one Internet protocol (IP) address subject to an IP warming process by a service provider, the volume of email communications sent to an IP warming audience determined via an audience orchestration module configured for the IP warming process. For example, the audience orchestration module 330 of IP warming module 320 operates to determine a target audience responsive to activation of a run of an IP warming plan. The audience orchestration module 330 performs one or more steps to exclude members from a base audience to generate the limited target audience. For instance, a suppressions step 902 removes recipients that have been associated with suppressions, such as opt-outs, unsubscribing, etc. are removed from base audience 911 to form audience 912. In another example, engaged profiles are selected to create an audience 914 that consists of members of audience 913 that meet certain engagement profiles (e.g., have engaged in the last 30 days, threshold engagement percentage, purchases, website visits, app usage, and/or the like). Other steps include removing targeted profiles (i.e., to ensure previously-targeted profiles are not included in a current phase), domain-based segmentation, and domain-based capping of audience members to limit the number of recipients for one or more destination domains.

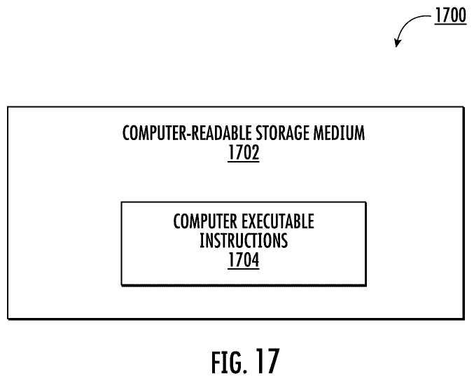

FIG. 17 illustrates an apparatus 1700. Apparatus 1700 comprises any non-transitory computer-readable storage medium 1702 or machine-readable storage medium. In various embodiments, apparatus 1700 comprises an article of manufacture or a product. In some embodiments, the computer-readable storage medium 1702 stores computer executable instructions with which one or more processing devices or processing circuitry can execute. For example, computer executable instructions 1704 includes instructions to implement operations described with respect to any logic flows described herein. Examples of computer-readable storage medium 1702 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1704 include any suitable type of code, such as source code, compiled code, interpreted code, executable code, static code, dynamic code, object-oriented code, visual code, and the like.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

In one embodiment, a computer-implemented method includes determining, via an audience orchestration module, an Internet protocol (IP) warming audience configured for an IP warming process; determining, via an IP warming module, an IP warming schema formed of a plan configured using a plan module, the IP warming plan including phases formed of a plurality of runs, wherein each run identifies a number of communications to transmit to at least one domain to the IP warming audience; and executing an IP warming process configured based on the IP warming schema for IP warming an IP address used to send communications.

In one embodiment, a computer-implemented method, includes building, via an IP warming module, an IP warming plan that includes a plurality of runs associated with at least one phase, wherein each of the plurality of runs identifies a number of emails to transmit to a plurality of email domains according to a domain split defining a division of the number of emails among the plurality of email domains; for each of the plurality of runs, determining, via an audience orchestration module, an IP warming audience comprising a set of email addresses for sending the number of emails based on at least one email engagement metric; and performing IP warming on an IP address used to send communications via executing the IP warming plan.

In some embodiments of the computer-implemented method, the at least one email engagement metric including at least one of a read rate, a predicted read rate, an opt-out rate, a predicted opt-out rate, a suppression, a predicted suppression.

In some embodiments of the computer-implemented method, the audience orchestration module is configured to determine the IP warming audience to include engaged profiles and to exclude targeted profiles.

In various embodiments of the computer-implemented method, the audience orchestration module is configured to determine the IP warming audience to include domain-based capping of audience members.

In some embodiments of the computer-implemented method, the method includes receiving metrics of the IP warming process indicating the success of the IP warming process, the metrics including one or more of click rates, read rates, delete rates, or suppression rates.

In exemplary embodiments of the computer-implemented method, the method includes configuring at least one rule, via a rule module, to intervene in an active IP warming process responsive to a condition.

In various embodiments of the computer-implemented method, the condition includes at least one of a spam percentage, a bounce-back percentage, a delete percentage, or a suppression percentage.

In some embodiments of the computer-implemented method, the method includes, via a phase module, splitting a phase of the IP warming process, wherein each run of a split phase is transferred to the new phase created to implement splitting of the phase.

In one embodiment, a computer-implemented method includes, via a server computing device of a content distribution system: transmitting, via a distribution module, a first run of emails for a first phase of a plurality of phases of an IP warming campaign to at least one service provider for distribution to a plurality of user devices, the first volume of emails determined based on an IP warming plan received at an IP warming module, the IP warming plan including: a plurality of phases, each phase comprising at least one run of emails for a plurality of recipient domains, the at least one run defining a different volume of emails and a different split of the emails for transmission among the plurality of domains, and at least one rule, defined via a rule module, operative to intervene in an active IP warming process responsive to a condition; and transmitting, via the distribution module, a second run of emails for a second phase of the IP warming campaign to the at least one service provider for distribution to the plurality of user devices, the second run of emails determined based on at least one distribution metric of the first run of emails triggering the condition of the at least one rule.

In some embodiments of the method, the condition includes at least one of a spam percentage, a bounce-back percentage, a delete percentage, or a suppression percentage.

In various embodiments of the method, the rule is configured to intervene in the active warming process via splitting a phase of the IP warming process to form a new phase, wherein each run of a split phase is transferred to the new phase created to implement splitting of the phase.

In exemplary embodiments of the method, the rule is configured to intervene in the active warming process via adding a phase to a current run of the IP warming plan.

In some embodiments of the method, the method further includes determining, via an audience orchestration module, an IP warming audience from a base audience configured for the IP warming process.

In various embodiments of the method, the IP warming audience is determined via segmenting recipients from the base audience based on domain and capping a number of audience members for at least one domain.

In some embodiments of the method, each phase of the plurality of phases of the IP warming plan is assigned a different email campaign.

In one embodiment, an apparatus includes at least one processor and at least one non-transitory storage media storing instructions. The instructions, when executed by the at least one processor, cause the at least one processor to perform operations including: executing a distribution module to transmit a volume of email communications using at least one Internet protocol (IP) address subject to an IP warming process by a service provider, the volume of email communications sent to an IP warming audience determined via an audience orchestration module configured for the IP warming process, wherein the volume of email communications is determined, via an IP warming module, based on an IP warming schema formed of a plan configured using a plan module, the IP warming plan includes phases formed of a plurality of runs, wherein each run identifies a number of email communications to transmit to at least one domain to the IP warming audience.

In some embodiments of the system, the audience orchestration module is configured to determine the IP warming audience to include engaged profiles and to exclude targeted profiles.

In various embodiments of the system, the audience orchestration module is configured to determine the IP warming audience to include domain-based capping of audience members.

In some embodiments of the system, the instructions, when executed by the at least one processor, cause the at least one processor to perform operations including receiving metrics of the IP warming process indicating the success of the IP warming process, the metrics comprising one or more of click rates, read rates, delete rates, or suppression rates.

In exemplary embodiments of the system, the instructions, when executed by the at least one processor, cause the at least one processor to perform operations including configuring at least one rule, via a rule module, to intervene in an active IP warming process responsive to a condition.

In various embodiments of the system, the condition includes at least one of a spam percentage, a bounce-back percentage, a delete percentage, or a suppression percentage.

In one embodiment, a system includes at least one processor and at least one non-transitory storage media storing instructions, that when executed by the at least one processor, cause the at least one processor to perform operations including: determining, via an audience orchestration module, an Internet protocol (IP) warming audience configured for an IP warming process, determining, via an IP warming module, an IP warming schema formed of a plan configured using a plan module, the IP warming plan including phases formed of a plurality of runs, wherein each run identifies a number of communications to transmit to at least one domain to the IP warming audience; and executing an IP warming process configured based on the IP warming schema for IP warming an IP address used to send communications.

In some embodiments of the system, the audience orchestration module is configured to determine the IP warming audience to include engaged profiles and to exclude targeted profiles.

In various embodiments of the system, the audience orchestration module is configured to determine the IP warming audience to include domain-based capping of audience members.

In some embodiments of the system, the instructions, when executed by the at least one processor, cause the at least one processor to perform operations including receiving metrics of the IP warming process indicating the success of the IP warming process, the metrics comprising one or more of click rates, read rates, delete rates, or suppression rates.

In exemplary embodiments of the system, the instructions, when executed by the at least one processor, cause the at least one processor to perform operations including configuring at least one rule, via a rule module, to intervene in an active IP warming process responsive to a condition.

In some embodiments of the system, the condition includes at least one of a spam percentage, a bounce-back percentage, a delete percentage, or a suppression percentage.

In various embodiments of the system, the instructions, when executed by the at least one processor, cause the at least one processor to perform operations including, via a phase module, splitting a phase of the IP warming process, wherein each run of a split phase is transferred to the new phase created to implement splitting of the phase.

In one embodiment, a non-transitory computer-readable medium stores executable instructions, which when executed by one or more processing devices, cause the one or more processing devices to perform operations including: determining, via an audience orchestration module, an Internet protocol (IP) warming audience configured for an IP warming process, determining, via an IP warming module, an IP warming schema formed of a plan configured using a plan module, the IP warming plan comprising phases formed of a plurality of runs, wherein each run identifies a number of communications to transmit to at least one domain to the IP warming audience; and executing an IP warming process configured based on the IP warming schema for IP warming an IP address used to send communications.

In some embodiments of the non-transitory computer-readable medium, the audience orchestration module is configured to determine the IP warming audience to include domain-based capping of audience members.

In various embodiments of the non-transitory computer-readable medium, the instructions, when executed by the one or more processing devices, cause the one or more processing devices to perform operations comprising receiving metrics of the IP warming process indicating the success of the IP warming process, the metrics comprising one or more of click rates, read rates, delete rates, or suppression rates.

In some embodiments of the non-transitory computer-readable medium, the instructions, when executed by the one or more processing devices, cause the one or more processing devices to perform operations comprising configuring at least one rule, via a rule module, to intervene in an active IP warming process responsive to a condition.

In exemplary embodiments of the non-transitory computer-readable medium, the condition including at least one of a spam percentage, a bounce-back percentage, a delete percentage, or a suppression percentage.

In various embodiments of the non-transitory computer-readable medium, the instructions, when executed by the one or more processing devices, cause the one or more processing devices to perform operations comprising, via a phase module, splitting a phase of the IP warming process, wherein each run of a split phase is transferred to the new phase created to implement splitting of the phase.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application, or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit. Circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines is apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects. The following examples pertain to further embodiments, from which numerous permutations and configurations will be apparent.

What is claimed is:

1. A computer-implemented method, comprising:
building, via an IP warming module, an IP warming plan comprising a plurality of runs associated with at least one phase, wherein each of the plurality of runs identifies a number of emails to transmit to a plurality of email domains according to a domain split defining a division of the number of emails among the plurality of email domains;
for each of the plurality of runs, determining, via an audience orchestration module, an IP warming audience comprising a set of email addresses for sending the number of emails determined based on at least one email engagement metric; and
performing IP warming on an IP address used to send communications via executing the IP warming plan.

2. The computer-implemented method of claim 1, the audience orchestration module configured to determine the IP warming audience to include engaged profiles and to exclude targeted profiles.

3. The computer-implemented method of claim 1, the audience orchestration module configured to determine the IP warming audience to include domain-based capping of audience members.

4. The computer-implemented method of claim 1, comprising receiving metrics of the IP warming process indicating the success of the IP warming process, the metrics comprising one or more of click rates, read rates, delete rates, or suppression rates.

5. The computer-implemented method of claim 1, comprising configuring at least one rule, via a rule module, to intervene in an active IP warming process responsive to a condition.

6. The computer-implemented method of claim 1, the condition comprising at least one of a spam percentage, a bounce-back percentage, a delete percentage, or a suppression percentage.

7. The computer-implemented method of claim 1, further comprising, via a phase module, splitting a phase of the IP warming process to form a new phase, wherein each run of a split phase is transferred to the new phase created to implement splitting of the phase.

8. A computer-implemented method, comprising, via a server computing device of a content distribution system:
transmitting, via a distribution module, a first run of emails for a first phase of a plurality of phases of an IP warming campaign to at least one service provider for distribution to a plurality of user devices, the first volume of emails determined based on an IP warming plan received at an IP warming module, the IP warming plan comprising:
a plurality of phases, each phase comprising at least one run of emails for a plurality of recipient domains, the at least one run defining a different volume of emails and a different split of the emails for transmission among the plurality of domains, and
at least one rule, defined via a rule module, operative to intervene in an active IP warming process responsive to a condition; and
transmitting, via the distribution module, a second run of emails for a second phase of the IP warming campaign to the at least one service provider for distribution to the plurality of user devices, the second run of emails determined based on at least one distribution metric of the first run of emails triggering the condition of the at least one rule.

9. The computer-implemented method of claim 8, the condition comprising at least one of a spam percentage, a bounce-back percentage, a delete percentage, or a suppression percentage.

10. The computer-implemented method of claim 1, the rule configured to intervene in the active warming process via splitting a phase of the IP warming process to form a new phase, wherein each run of a split phase is transferred to the new phase created to implement splitting of the phase.

11. The computer-implemented method of claim 1, the rule configured to intervene in the active warming process via adding a phase to a current run of the IP warming plan.

12. The computer-implemented method of claim 1, further comprising determining, via an audience orchestration module, an IP warming audience from a base audience configured for the IP warming process.

13. The computer-implemented method of claim 1, the IP warming audience determined via segmenting recipients from the base audience based on domain and capping a number of audience members for at least one domain.

14. The computer-implemented method of claim 1, each phase of the plurality of phases of the IP warming plan is assigned a different email campaign.

15. An apparatus, comprising:
at least one processor; and
at least one non-transitory storage media storing instructions, that when executed by the at least one processor, cause the at least one processor to perform operations including:
executing a distribution module to transmit a volume of email communications using at least one Internet protocol (IP) address subject to an IP warming process by a service provider, the volume of email communications sent to an IP warming audience determined via an audience orchestration module configured for the IP warming process,
wherein the volume of email communications is determined, via an IP warming module, based on an IP warming schema formed of a plan configured using a plan module, the IP warming plan comprising phases formed of a plurality of runs, wherein each run identifies a number of email communications to transmit to at least one domain to the IP warming audience.

16. The system of claim 8, the audience orchestration module configured to determine the IP warming audience to include engaged profiles and to exclude targeted profiles.

17. The system of claim 8, the audience orchestration module configured to determine the IP warming audience to include domain-based capping of audience members.

18. The system of claim 8, the instructions, when executed by the at least one processor, to cause the at least one processor to perform operations including receiving metrics of the IP warming process indicating the success of the IP warming process, the metrics comprising one or more of click rates, read rates, delete rates, or suppression rates.

19. The system of claim 8, the instructions, when executed by the at least one processor, to cause the at least one processor to perform operations including configuring at least one rule, via a rule module, to intervene in an active IP warming process responsive to a condition.

20. The system of claim 8, the condition comprising at least one of a spam percentage, a bounce-back percentage, a delete percentage, or a suppression percentage.
